(19) United States
(12) Patent Application Publication
(10) Pub. No.: US 2025/0281795 A1
(43) Pub. Date: Sep. 11, 2025

(54) TRAINING AND INFERENCE OF AN AUTOMATED MACHINE LEARNING MODEL FOR DETECTING POSITION OF A MOVING OBJECT RELATIVE TO A REFERENCE OBJECT IN A SPORTING OR OTHER EVENT

(71) Applicant: Big League Ballpark Inc., Sausalito, CA (US)

(72) Inventors: Rob Regan, Sausalito, CA (US); Mike Milmoe, Sausalito, CA (US); Rick Palmer, West Linn, OR (US)

(73) Assignee: Big League Ballpark Inc., Sausalito, CA (US)

(21) Appl. No.: 19/073,840

(22) Filed: Mar. 7, 2025

Related U.S. Application Data
(60) Provisional application No. 63/562,981, filed on Mar. 8, 2024.
(60) Provisional application No. 63/681,464, filed on Aug. 9, 2024.
(60) Provisional application No. 63/719,880, filed on Nov. 13, 2024.

(51) Int. Cl. A63B 24/00; G06T 7/246; G06T 7/73; G06V 10/774

(52) U.S. Cl. CPC A63B 24/0021; G06T 7/246; G06T 7/73; G06V 10/774; A63B 2024/0034; G06T 2207/20081; G06T 2207/30224

(57) ABSTRACT

A system is disclosed for training and inference (implementation) of a machine learning model (“MLM”) for automated determination of a position of a moving object relative to a reference object. Such a system may for example be trained and used to call balls and strikes in baseball and softball games. The training and inference of the MLM may be accomplished using a single, off-the-shelf camera, such as those incorporated in iPhones, Androids, Google and other mobile phones.

This application claims priority to U.S. Provisional Patent Application No. 63/562,981 filed on Mar. 8, 2024 entitled “TRAINING AND INFERENCE OF AN AUTOMATED MACHINE LEARNING MODEL FOR CALLING BALLS AND STRIKES IN A BASEBALL/SOFTBALL GAME”, U.S. Provisional Patent Application No. 63/681,464 filed on Aug. 9, 2024 entitled “TRAINING AND INFERENCE OF AN AUTOMATED MACHINE LEARNING MODEL FOR DETECTING POSITION OF A MOVING OBJECT RELATIVE TO A REFERENCE OBJECT IN A SPORTING OR OTHER EVENT”, and U.S. Provisional Patent Application No. 63/719,880 filed on Nov. 13, 2024 entitled “TRAINING AND INFERENCE OF AN AUTOMATED MACHINE LEARNING MODEL FOR DETECTING POSITION OF A MOVING OBJECT RELATIVE TO A REFERENCE OBJECT IN A SPORTING OR OTHER EVENT”, which applications are incorporated by reference herein in their entirety.

### BACKGROUND

Many sports involve judging the position of a moving object relative to a reference object. One example is baseball or softball, where an umpire needs to judge the relative position of a ball (moving object) to a strike zone (reference object) and then render that judgment as a ball or strike call. There are many other examples in ball/bat sports such as cricket, and in other sports such as racquet and paddle sports, football, basketball, hockey, volleyball, etc.

Returning to the baseball example, there is a national shortage of umpires to officiate amateur baseball and softball games such as youth, club, junior high and high school games. Automated officiating systems are known for officiating baseball/softball games. However, such conventional systems use multiple cameras and sophisticated, expensive equipment for determining when a pitch passes through the strike zone. They also require complex calibration processes to work at specific fields. As such, known automated systems for calling balls and strikes are not practical for use in amateur games.

### DESCRIPTION OF THE DRAWINGS

FIG. 1 is a perspective view of a system for training an automated umpiring machine learning model according to embodiments of the present technology.

FIG. 2 is a further perspective view of a system for training an automated umpiring machine learning model according to embodiments of the present technology.

FIG. 3 is a further perspective view of a system for training an automated umpiring machine learning model according to embodiments of the present technology.

FIG. 4 is a flowchart showing steps for training an automated umpiring machine learning model according to embodiments of the present technology.

FIG. 5 is an image used to train an automated umpiring machine learning model according to embodiments of the present technology.

FIG. 6 is a ground truth image used to train an automated umpiring machine learning model according to embodiments of the present technology.

FIG. 7 is a top view of a system for training an automated umpiring machine learning model including sensors for providing ground truth data according to alternative embodiments of the present technology.

FIG. 8 is a top view of a system for training an automated umpiring machine learning model to learn the position of an image capture device capturing an image of the field.

FIG. 9 is a flowchart for the inference of a machine learning model and other algorithms for calling balls and strikes in a baseball or softball game.

FIG. 10 is a flowchart showing further detail of step 256 of FIG. 9 for constructing a strike zone according to embodiments of the present technology.

FIG. 11 is a flowchart showing further detail of step 256 of FIG. 9 for constructing a strike zone according to further embodiments of the present technology.

FIG. 12 is a flowchart showing further detail of step 256 of FIG. 9 for constructing a strike zone according to further embodiments of the present technology.

FIG. 13 is a perspective view of a system for inferring an automated umpiring machine learning model according to embodiments of the present technology.

FIG. 14 is a further perspective view of a system for inferring an automated umpiring machine learning model according to embodiments of the present technology.

FIG. 15 is a further perspective view of a system for inferring an automated umpiring machine learning model according to embodiments of the present technology.

FIG. 16 is an image captured during a calibration step for selecting a position of home plate.

FIG. 17 is an image captured during a calibration step of selecting a position of a pitcher's mound.

FIG. 18 is an image captured by an image capture device used by an automated umpiring application calling balls and strikes in a game according to embodiments of the present technology.

FIG. 19 is an enlarged view of a portion of FIG. 18.

FIG. 20 is a perspective view of a strike zone constructed over home plate according to embodiments of the present technology.

FIGS. 21 and 22 show graphical user interfaces for manually setting a strike zone for an automated umpiring application calling balls and strikes in a game according to embodiments of the present technology.

FIG. 23 is an illustration of a 3-dimensional strike zone for an automated umpiring application calling balls and strikes in a game according to embodiments of the present technology.

FIG. 24 is an illustration of a 3D reference frame used by the umpiring application of the present technology.

FIG. 25 is a captured image of a ball appearing in 2D within the strike zone prior to the ball reaching the strike zone

FIG. 26 is a captured 3D image of a field for implementing an automated umpiring application according to embodiments of the present technology.

FIG. 27 is a captured 3D image of a field and augmented reality pitch tunnel for implementing an automated umpiring application according to embodiments of the present technology.

FIG. 28 is a view of an alternative embodiment of the present technology using two image capture devices to determine a 3D position of a pitched baseball.

FIG. 29 is a schematic block diagram of a computing environment according to embodiments of the present technology.

### DETAILED DESCRIPTION

The present technology will now be described with reference to the figures, which in general relate to a system for training of a machine learning model (“MLM”) for detecting the position of one or more moving objects relative to one or more stationary reference objects, for example in a sporting event. In one example, the moving object may be a baseball or a softball and the reference object may be a home plate, thus enabling the present system to train an MLM to call balls and strikes in a baseball or softball game.

The present technology further relates to the inference (implementation) of an MLM for detecting the position of a moving object relative to a stationary reference object, for example in a sporting event. Continuing with the above example, the trained MLM may detect whether a baseball or softball (the moving object) passes through a strike zone (the reference object), thus enabling the present system to call balls and strikes in a baseball or softball game.

The training and inference of the MLM may be accomplished using a single, off-the-shelf camera, such as those incorporated in iPhones and other mobile phones. The MLM of the present system may be used to assist a home plate umpire, providing feedback to the umpire confirming whether or not a pitch crossed through the strike zone. Alternatively, the MLM of the present technology may be used in the place of an umpire, providing visual and/or audible feedback as to whether or not a pitch crossed through the strike zone. In this mode, the MLM may perform other functions of a home plate umpire, such as keeping track of balls and strikes, and responding to verbal prompts from coaches or players.

While in the example above, the moving object is a baseball or softball and the reference object is a home plate, it is understood that these objects may be different in further embodiments. As another example, the moving object may be a foot and the reference object may be first base, second base, third base or home plate, or the reference object may be a ball thrown to a base and the reference object may be a mitt catching the ball. These scenarios may be used in conjunction to allow the present system to be trained and used to judge when a baserunner in baseball or softball is safe or out at a base or home plate, or other officiating purposes. There are many other examples in ball/bat sports such as cricket, and in other sports such as racquet and paddle sports, football, basketball, hockey, volleyball, etc., where the present system may be trained and used to detect the position of a moving object relative to a reference object. Some of these are explained below.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The terms “top” and “bottom,” “upper” and “lower” and “vertical” and “horizontal” as may be used herein are by way of example and illustrative purposes only, and are not meant to limit the description of the invention inasmuch as the referenced item can be exchanged in position and orientation. Also, as used herein, the terms “substantially,” “approximately” and/or “about” mean that the specified dimension or parameter may be varied within an acceptable manufacturing tolerance for a given application. In one embodiment, the acceptable manufacturing tolerance is ±0.15 mm, or alternatively, ±2.5% of a given dimension.

For purposes of this disclosure, a physical or electrical connection may be a direct connection or an indirect connection (e.g., via one or more other parts). In some cases, when a first element is referred to as being connected, affixed, mounted or coupled to a second element (either physically or electrically), the first and second elements may be directly connected, affixed, mounted or coupled to each other or indirectly connected, affixed, mounted or coupled to each other (either physically or electrically). When a first element is referred to as being directly connected, affixed, mounted or coupled to a second element, then there are no intervening elements between the first and second elements (other than possibly an adhesive or melted metal used to connect, affix, mount or couple the first and second elements).

### Model Training Phase

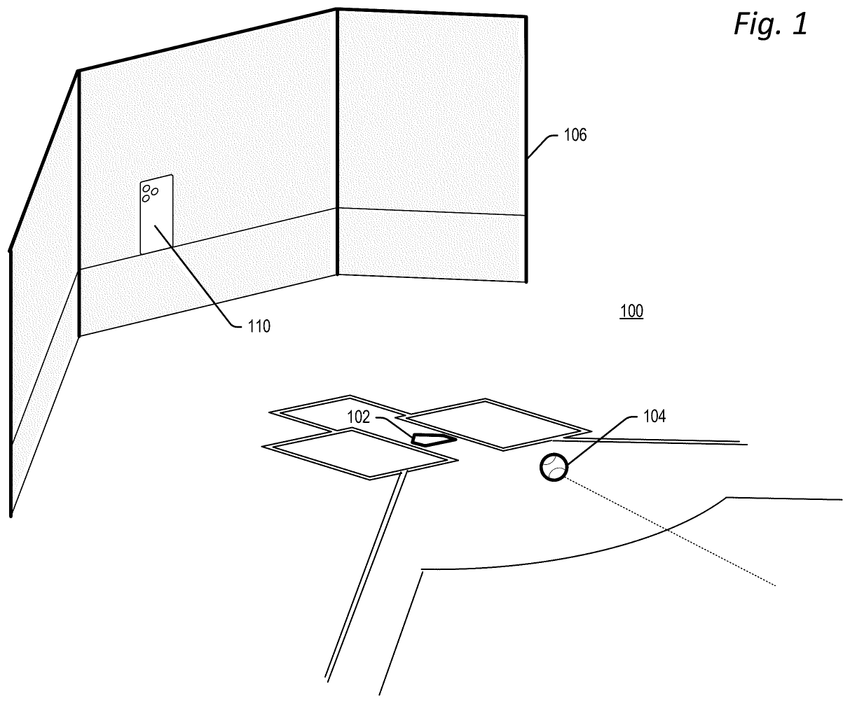

A first portion of the present technology involves training of an MLM, or other artificial intelligence model, to detect one or more moving objects and one or more reference objects in a frame of video. This portion of the present technology will now be described with reference to FIGS. 1-8. In the example described in FIGS. 1-8, the moving object may be a baseball or softball 104 and the reference object may be a home plate 102 on a baseball or softball field 100. For such embodiments, the MLM, or other artificial intelligence model, described below, may also be referred to herein using its tradename BLU™ machine learning model baseball/softball officiating system, or simply “BLU”. In the examples described below, the present technology involves training BLU to identify a home plate and a pitched ball from a frame of video during a baseball or softball game. However, as noted and described below, the moving object and the reference object may be other objects from other sports or activities in further embodiments.

FIGS. 1-3 are views of a portion of a baseball field 100 showing a home plate 102 and a pitched baseball 104. The description that follows relates to tracking a baseball in a baseball game, but it is understood that the following description is applicable in the same way to tracking a softball in a softball game. FIGS. 1-3 further show an image capture device 110 for capturing images of the baseball field 100 including home plate 102 and the ball 104. These images are used to train BLU to identify home plate and a pitched ball in any of a variety of conditions as explained below. It is a feature of the present technology that BLU may be trained using a single, off-the-shelf image capture device such as a single, standard iPhone. However, in general, image capture device 110 for training BLU may be any of a wide variety of commercially available, inexpensive devices including image capture and processing capabilities. These other devices include but are not limited to Android, Google and other mobile phones, still image and video cameras such as GoPro® mobile cameras, and laptops, iPads and other hand-held or mobile computing devices. In further embodiments, the device 110 may be a dedicated device; i.e., one that is dedicated to training BLU and has no other uses than training BLU.

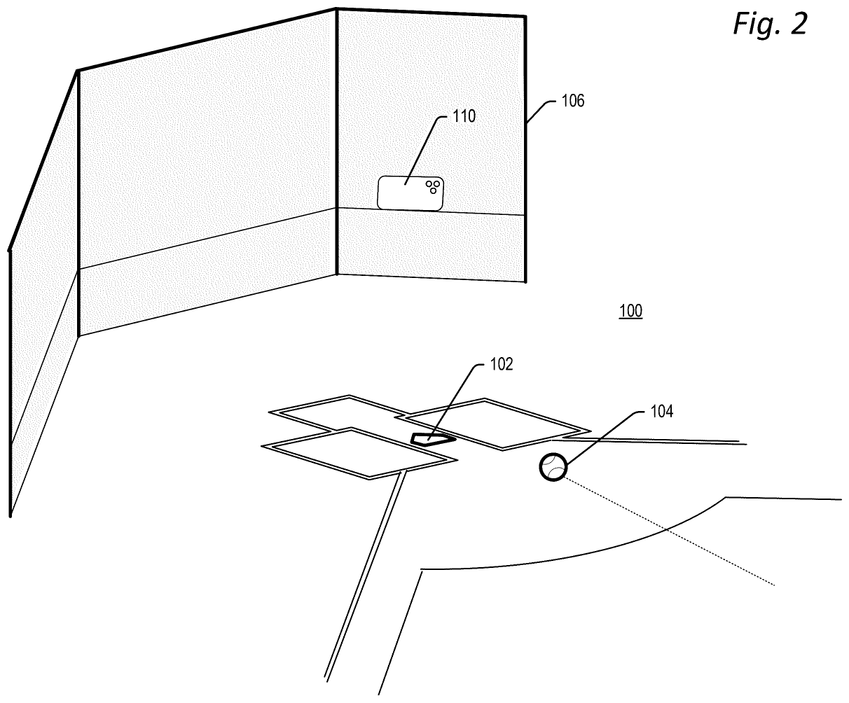

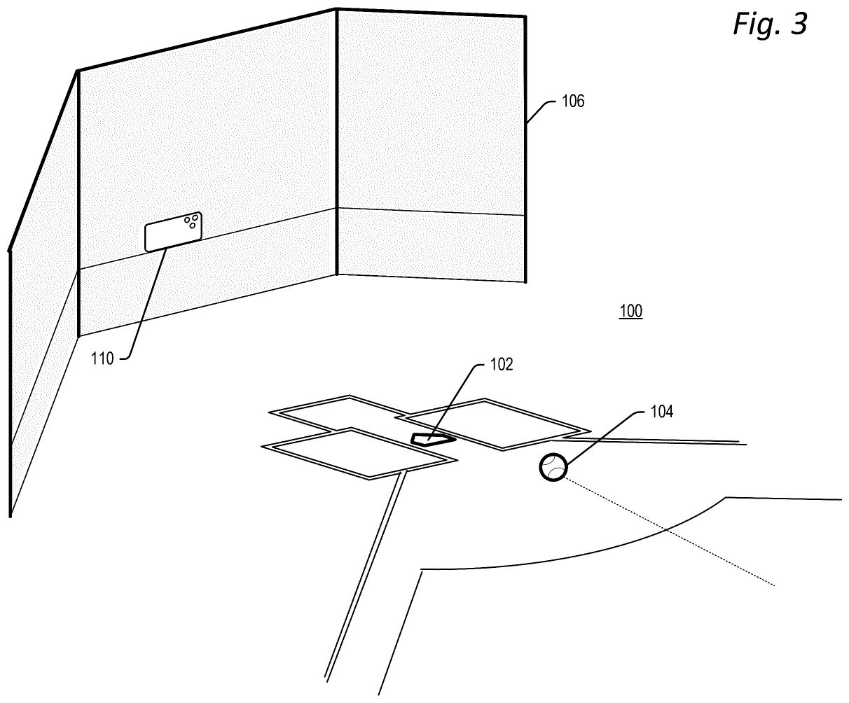

FIGS. 1-3 illustrate different positions and orientations of camera 110 for capturing images of home plate 102 and ball 104 for training BLU. It is a feature of the present technology that there are no precise positioning requirements for image capture device 110 for capturing training images, and the device 110 may be placed in a variety of user-selected positions. In the illustrated embodiments, the image capture device is mounted on a backstop 106, as most fields 100 have a backstop 106 on which the image capture device 110 may be easily mounted at a variety of positions to capture images of home plate 102 and a ball 104. When located on a backstop 106, the camera may be located anywhere on the backstop with a view of home plate and pitches. As noted, the camera may be oriented in a variety of orientations. One such orientation is vertical (FIG. 1) and another such orientation is horizontal (FIGS. 2-3), but other orientations between horizontal and vertical are possible. The image capture device 110 may be placed behind the backstop 106 (on a side of the backstop opposite the field), or in front of the backstop 106 (on a side of the backstop facing the field). When on the front of the backstop, the image capture device 110 may be encased in a protective, transparent housing, such as clear plastic. The protective housing may be omitted in further embodiments.

Further still, the image capture device 110 need not be placed on the backstop 106 in further embodiments. The device 110 may alternatively be hand-held or mounted on a tripod or other stand. In further embodiments, the image capture device may be mounted to a helmet of a catcher or umpire to capture training images of home plate 102 and ball 104. In still further embodiments, the mobile phone or video camera 110 may be affixed to a drone (not shown), traveling above the field 100 and capturing images of home plate 102 and a pitched ball 104.

In order to effectively determine balls and strikes, BLU will need to recognize home plate and a pitched ball in a wide variety of different conditions. As explained below, these conditions include different lighting and shade conditions, different shades of home plate and the baseball, and different positions and vantage points from which a pitch is captured. Moreover, as also explained below, a baseball in flight has a variety of different appearances when captured in an image. In the inference phase, BLU may need to recognize home plate 102 and baseball 104 from an image of the home plate 102 and baseball 104 in each of these different conditions. As explained below, BLU may be trained to recognize home plate 102 and baseball 104 using only the two-dimensional (2D) data available from an image captured by the capture device 110. However, in further embodiments, BLU may be trained to recognize home plate 102 and baseball 104 using captured three-dimensional (3D) data as explained below.

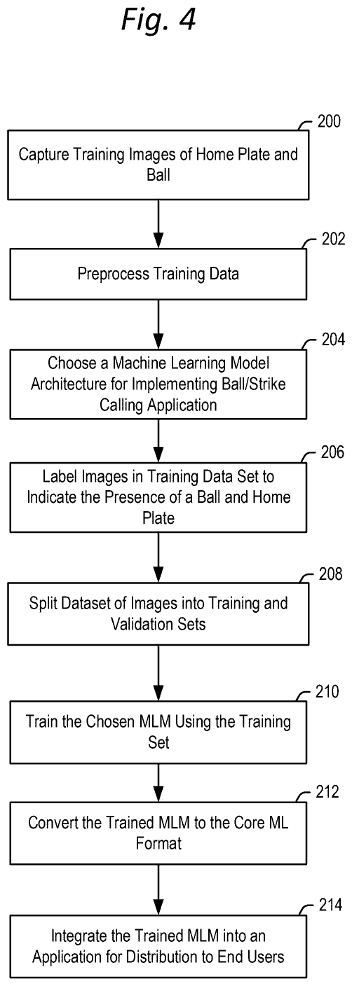

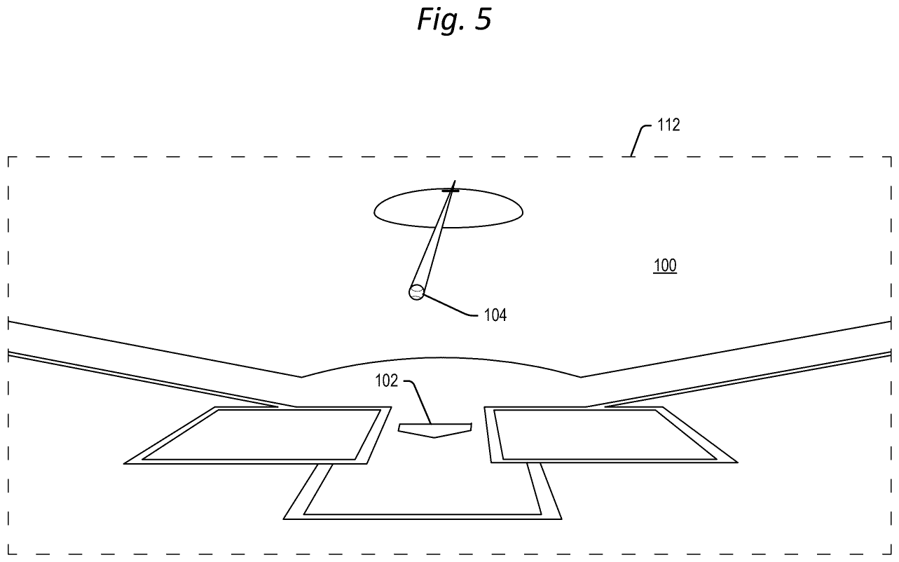

FIG. 4 shows a flowchart for training BLU to recognize a reference object, such as a home plate, and a moving object, such as a pitched ball, from a variety of images (or other data) under a variety of different conditions. A first step 200 in training BLU is to capture a large number of training images of home plate 102 and ball 104. FIG. 5 shows one example of an image frame 112 captured by device 110 showing home plate 102 and a pitched ball 104 (ball 104 is shown with a contrail in FIG. 5 to indicate its motion, but no such contrail would exist in the actual captured image). The number of images needed of a home plate and ball may vary, but in embodiments, hundreds or even thousands of images may be used.

The training images may be captured in a variety of conditions, including different lighting conditions, different degrees of shading and/or different weather conditions (light rain or shine). The images may be taken without varying these conditions in further embodiments. The training images may be captured with a variety of different backgrounds, including different appearances of the fields on which pitches are thrown. The images may be taken without varying the background in further embodiments. The training images may be captured from a variety of different vantage points, including from behind and to the left of home plate 102, behind and to the right of home plate 102, from straight behind home plate and/or straight above home plate. The images may also be captured from different distances between a capture device and home plate. The images may be taken without varying the vantage point in further embodiments. The training images may be captured with a variety of image capture parameters including different depth of field, and frame rates of 30, 60 or 90 frames per second. The images may additionally or alternatively be captured in slow motion including 120 or 240 frames per second. Other frame rates are possible. The images may be taken without varying the camera parameters in further embodiments. The images may also be captured using a variety of different types of capture devices.

While FIG. 5 shows an image of a ball 104 in motion, the training images may include a baseball in motion or a stationary baseball. However, when a pitched baseball in motion is captured by BLU during the inference phase, it may have a variety of appearances in the captured image. Given its fast motion, it may appear blurred and/or with different shapes (including circular and elliptical). It may appear with different colors, shades and shadows. The laces may appear in a variety of different orientations. It may be spinning about different axes (depending on the type of pitch) or it may have no rotation (in the case of a knuckle ball). Therefore, in embodiments, a variety of images may be captured of the ball in motion during the training phase of BLU so that BLU can learn to identify a baseball in any of its appearances in an image frame during the inference phase.

The images captured in step 200 may be input to and processed by a software tool to train BLU to recognize a pitched ball and home plate in captured images. As noted, in one embodiment, iPhones may be used during the inference phase to capture pitched baseballs. As such, in one embodiment, the software tool used to train BLU using the sample images may be Core ML. Core ML is a framework developed by Apple Inc. that is used to create and integrate machine learning models into iOS applications.

Using Core ML for example, the data collected in step 200 may be preprocessed in a step 202 to ensure consistency of all images used for training. Step 202 may involve any of a variety of processes including noise reduction to improve image quality, resizing the images to a standard size, orienting images to a standard orientation and/or normalizing pixel values to a common scale (e.g., 0 or 1). Preprocessing step 202 may involve processes in addition to or instead of those set forth above.

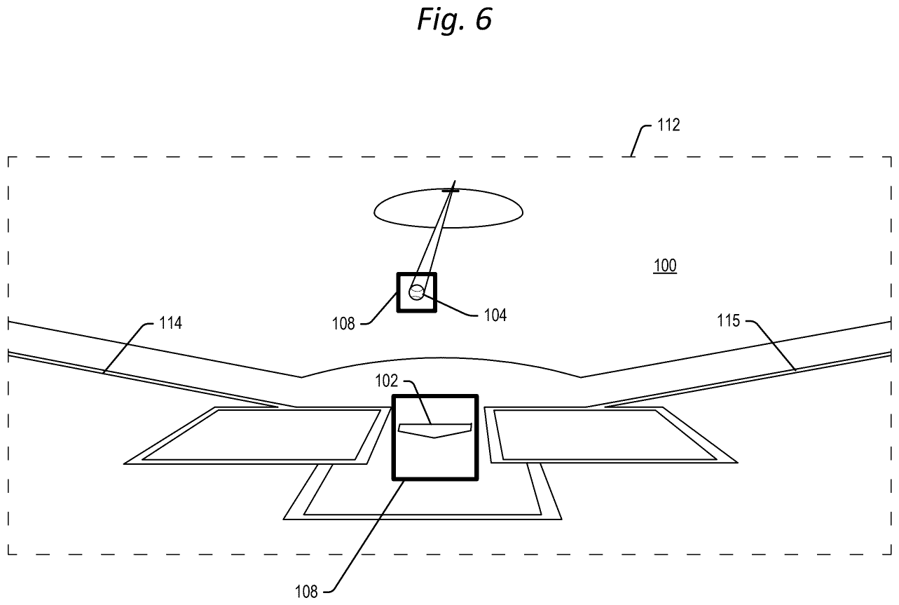

In step 204, an MLM architecture is chosen for implementation of BLU, such as for example a convolutional neural network (CNN). In step 206, some or all images in the dataset are labeled to indicate whether they contain a ball or a home plate (referred to as “ground truths”). This labeling may occur by automatic methods or by manual methods. FIG. 6 is an example where the ball 104 and home plate 102 have been labeled by providing a bounding box 108 around the ball 104 and home plate 102. The bounding box 108 is shown as a square, but it may be other geometric shapes in further embodiments. As noted, in one example, these bounding boxes 108 may be manually added to the image shown in FIG. 6. In further embodiments, the bounding boxes 108 may be automatically generated around the plate 102 and ball 104, and then manually checked and, if necessary, corrected. Automatic methods including object detection techniques and using a trained version of BLU as explained in the following paragraph. Images including the bounding boxes 108 are used as ground truth images of home plate, and images including bounding boxes 108 are used as ground truth images of the ball 104. It is noted here that the ground truth images use only 2D data to train BLU.

Ground truth images including confirmed images of home plate 102 and/or the ball 104 may be generated by other heuristic techniques in further embodiments, for example using other contextual features of the baseball field or characteristics of the home plate and ball using only 2D data from an image and/or a single capture device 110. For example, most baseball fields include foul lines 114, 115 shown for example in FIG. 5. It is a known characteristic of the foul lines 114 and 115 that they converge to a point at home plate 102, specifically, at the rearmost point on home plate 102 where the two diagonal edges of home plate come together. Thus, BLU may be trained to identify the foul lines 114 and 115, and then determine where they converge. This point of convergence may then be used to identify the ground truth position of home plate in an image using only 2D data from the image. It is also true that this point of convergence may be used to identify the ground truth position of home plate in an image using only a single image capture device 110.

In a further example, a ball may be identified by identifying a pitcher, and the pitcher going through a motion resulting in release of an object. That object may be positively identified as the baseball 104 using only 2D data from an image and/or using only a single image capture device 110. In embodiments, BLU may also receive training images enabling it to identify a pitcher. In the same way, images may include a catcher, sitting in a crouched position. The home plate may be positively identified as being just in front of the crouching catcher using only 2D data from an image and/or using only a single image capture device 110. Again, in embodiments, BLU may be trained with images enabling it to identify a crouching catcher.

In a further example, a pitched baseball will travel along a path that is somewhat linear (allowing for curveballs and other pitches that intentionally follow an arc) and at a somewhat constant velocity (allowing for the effects of wind and friction which may slightly affect the velocity of a pitch as moves toward home plate). Thus, a baseball 104 may be identified in successive image frames from a video of a pitch by examining the frames and identifying an object whose position in each frame has changed in a way that indicates: 1) movement of the object from the pitcher's mound toward home plate, 2) along a generally linear path, and/or 3) which moves with a generally constant velocity. Any one or more of these three characteristics of an object in successive image frames may be used as ground truth that such an identified object is in fact a ball 104, again using only 2D from successive images. It is also true that any one or more of these three characteristics of an object in successive image frames may be used as ground truth that such an identified object is in fact a ball 104, again using only a single image capture device 110 and 2D data.

In a further example, current image capture devices 110, such as iPhones, Android phones and Google phones to name a few, capture and store a variety of metadata in addition to the image for an image frame. It is possible that this metadata may further be used to positively identify a home plate and/or ball from an image frame. This metadata may be used by itself, or in combination with other techniques described herein, to provide ground truth identification of a home plate 102 and/or ball 104 using only 2D image data and/or using only a single capture device 110. Nonlimiting examples of the type of metadata from device 110 that may be used in this regard include geolocation metadata, scene light and color metadata, and metadata related to the detection of faces, body elements, and scene features and objects.

The above provides a description of a few practical and heuristic techniques for accomplishing manual and automatic ground truth identification of home plate 102 and balls 104 using 2D image data and/or using a single image capture device 110. It is understood that other practical or heuristic techniques for ground truth identification of home plate 102 and/or balls 104 may be used in further embodiments using only the 2D data available from captured images and/or using only a single image capture device 110.

In step 208, the dataset of images may be split into training and validation sets, with the validation sets including the ground truth images including boundary boxes 108 or other indicator. In step 210, the training data set is used to train the chosen MLM architecture and the validation data set is used to evaluate the model's performance. The training step may use techniques such as transfer learning or fine-tuning to iteratively adjust the model's parameters (weights and biases) to minimize the error between the predictions made by the model and the ground truths provided in the training data set. In step 212, the trained MLM may be converted to the Core ML format and tested to ensure compatibility. In step 214, the trained MLM may be integrated into an application for distribution to and inference by end users. As explained below, the finished application may include code to load BLU from local memory or a server to receive and process input images and to identify the home plate 102 and ball 104 in the processed images in real-time.

It is understood that the Core ML model for training BLU may include additional and/or alternative steps in further embodiments. It is also understood that BLU may be honed and finetuned over time using additional acquired image data. It is further understood that other software tools may be used instead of Core ML to generate BLU for use on Apple iOS and other operating systems such as those implemented on Android phones.

As noted above, it is a feature of the present technology that the training of BLU (and more generally any MLM implementing the present technology) may be carried out by a single, off-the-shelf image capture device such as a single, standard iPhone. In general, image capture device 110 for training BLU (and more generally any MLM implementing the present technology) may be any of a wide variety of commercially available, inexpensive devices including image capture and processing capabilities. These other devices include but are not limited to Android, Google and other mobile phones, still image and video cameras such as GoPro® mobile cameras, and laptops, iPads and other hand-held or mobile computing devices.

Moreover, as noted above, it is a feature of the present technology that BLU (or more generally any MLM implementing the present technology) may be trained using only 2D images from capture devices 110. In particular, BLU (or more generally any MLM implementing the present technology) may be trained to recognize the reference object (such as home plate) and the moving object (such as a thrown ball) using only 2D images captured image capture devices 110 such as an iPhone. Once trained, BLU (or more generally any MLM implementing the present technology) may recognize the reference and moving objects from images captured on the image capture device, such as a standard iPhone, as explained below.

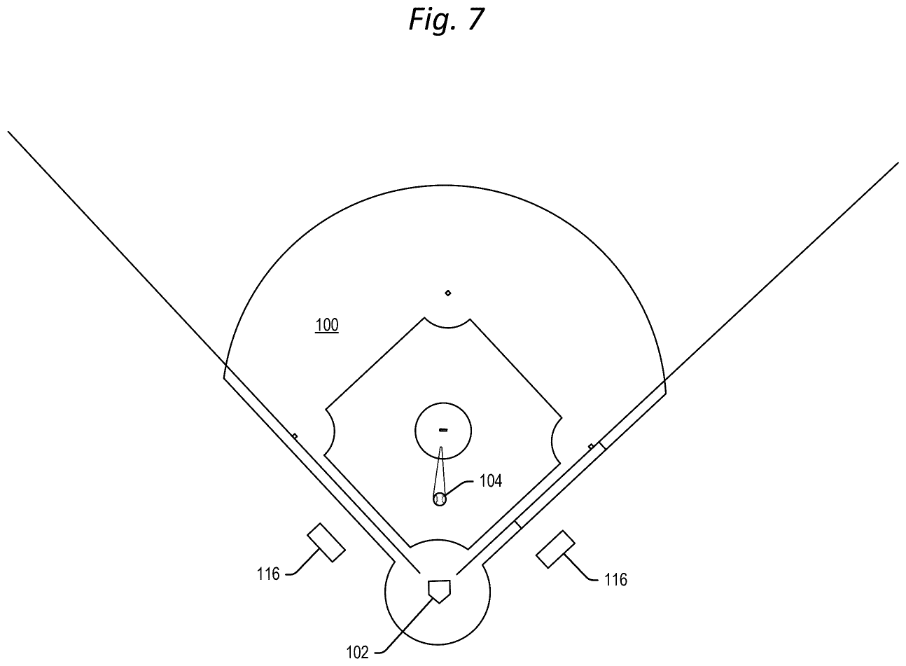

While it is a feature of the present technology that it may be trained using a single device and/or only 2D data, in further embodiments, 3D data and/or multiple devices may be used to train BLU in addition to or instead of a single device and 2D image data. FIG. 7 is a view of a baseball field 100 including a pair of sensors 116 that work together, possibly also in combination with image capture device 110, to determine an actual 3D position of the reference object (home plate 102 in this example) in a defined 3D reference system, and to determine an actual 3D position of the moving object (ball 104 in this example) in the defined reference system.

Further details of a system using sensors to determine 3D data of a moving and reference object are disclosed in U.S. Pat. No. 11,893,808, to Sahai et al, entitled “Learning-Based 3D Property Extraction,” which patent is incorporated herein by reference in its entirety. However, in general, this embodiment may include an image capture device 110 that captures 2D images of the reference and moving objects, and 3D sensors 116 that capture actual 3D positional data of the same objects to be used as ground truth. Both the 2D images and the 3D positional data include the moving and reference objects.

The 2D images from device 110 and the 3D data from the sensors 116 are time-stamped to ensure they can be accurately correlated to each other. This allows each 2D image to be matched with the corresponding 3D positional data captured at the same time. The time-stamped 2D images and the correlated 3D ground truth data are fed into the MLM. The MLM processes the 2D images to predict the 3D positions of the moving and reference objects from the 2D images. These predicted 3D positions are then compared to the actual 3D positions provided by the ground truth 3D sensor data. The MLM is trained by adjusting its parameters based on the deviations between the predicted 3D positions and the actual 3D ground truth data. This iterative process continues until the MLM can accurately predict the 3D positions of objects from the 2D images.

The positions of the 3D sensors relative to each other are known and mapped to each other in a common coordinate system or frame of reference. As noted, the 3D sensors 116 may capture time-stamped data allowing the sensors to triangulate the actual (ground truth) 3D positions of the moving and reference objects at given instances of time. While two 3D sensors 116 are shown, one along the first base line and one along the third base line, it is understood that there may be more than two 3D sensors 116, and the sensors 116 may be placed at other and/or additional positions on, around or over field 100.

The 3D sensors may for example be depth sensors, and/or may operate using radar, lidar or the like. In further embodiments, the 3D sensors may be image capture devices that are similar or identical to image capture devices 110. In such embodiments, the sensors may use computer vision technology based on the time-stamped capture of the moving and reference objects from different perspectives. By analyzing the differences between the images (disparity), the depth information can be extracted, allowing for triangulation of the objects' positions. Advanced techniques like structure-from-motion (SfM) and photogrammetry can also be employed.

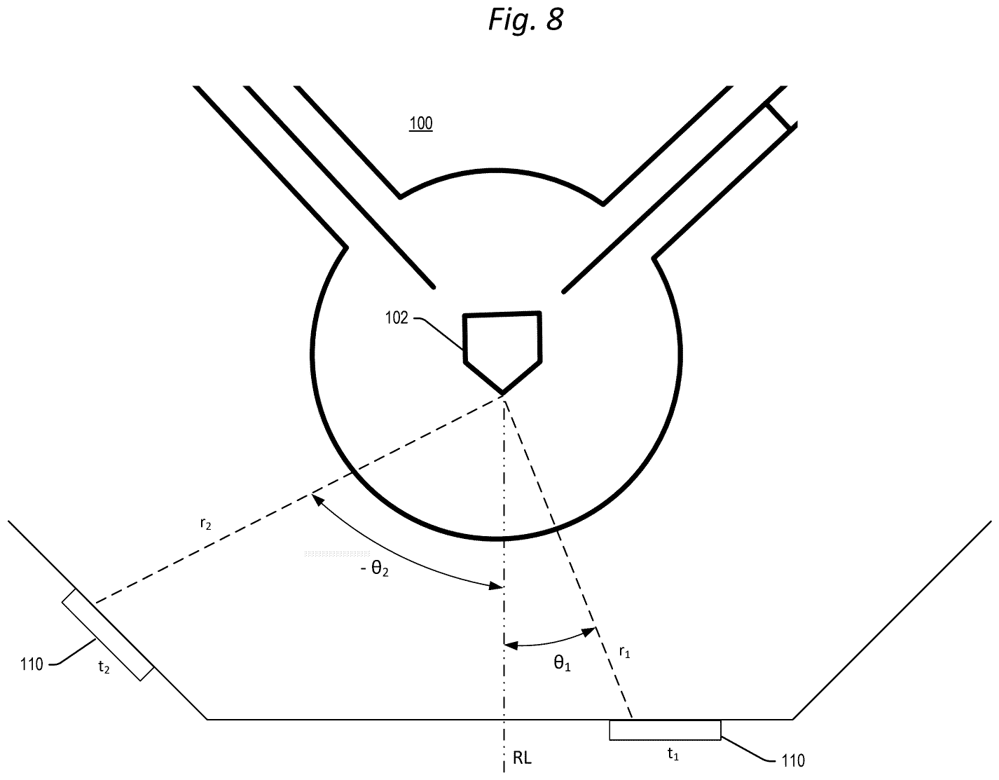

In embodiments described above, BLU was trained to detect the home plate 102 and ball 104 from an image of at least a portion of a field 100. In further embodiments, BLU may further be trained to determine the position of the capture device 110 relative to home plate 102 when capturing images. Training BLU to determine this information may aid in the inference phase of BLU as explained below. Examples of how to train BLU to determine the capture device position relative to home plate will now be described with reference to the top view of FIG. 8.

Sample images of home plate 102 and ball 104 are captured as described above. Additionally, BLU is fed ground truth data as to the position of the capture device 110 from which a given image is captured. This ground truth data may be gathered manually or automatically. In FIG. 8, a first image is captured by capture device 110 at time t1. The distance and offset angle of the capture device 110 relative to home plate 102 at time t1 are also stored and used as ground truth data when training BLU. In FIG. 8, this distance and offset angle are provided as polar coordinates (r₁, θ₁), where θ is taken relative to some reference line, RL, for example straight back from home plate 102.

A second image is captured by the capture device 110 at time t₂. The distance and offset angle of the capture device 110 relative to home plate 102 at time t₂ are also stored and used as ground truth data when training BLU. In FIG. 8, this distance and offset angle are provided as polar coordinates (r₂, θ₂), where θ is taken relative to the reference line, RL. Positive and negative signs may be used on the recorded angle to indicate which side of the reference line, RL, the image is captured from. This process may be repeated from different positions of capture device 110 a sufficient number of times to train BLU to recognize the distance and offset angle of the capture device and home plate in the implementation phase explained below.

While polar coordinates are described above, it is understood that the different distances and offset angles of the capture device 110 relative to home plate 102 may be expressed and recorded as Cartesian (x,y) coordinates. The distance and offset angle of the capture device 110 to home plate 102 may be manually measured and stored in association with a captured image. Instead of manually entering these measurements, the distance and offset angle may be automatically determined using capabilities of the capture device 110, machine vision algorithms and/or heuristic techniques. For example, using the fixed and known positions of the bases (first, second and/or third), the pitcher's mound and/or the foul lines relative to home plate, capture of one or more of the bases, mound and foul lines together with home plate in an image may be sufficient for the capture device 110 to determine its position relative to home plate 102, and then store this information in association with the captured image.

In the embodiments described above, BLU has been trained to recognize a reference object in the form of home plate 102. In the same way, BLU may be trained to recognize other reference objects on field 100 such as the pitcher's mound and the bases during the inference phase.

### Inference Phase

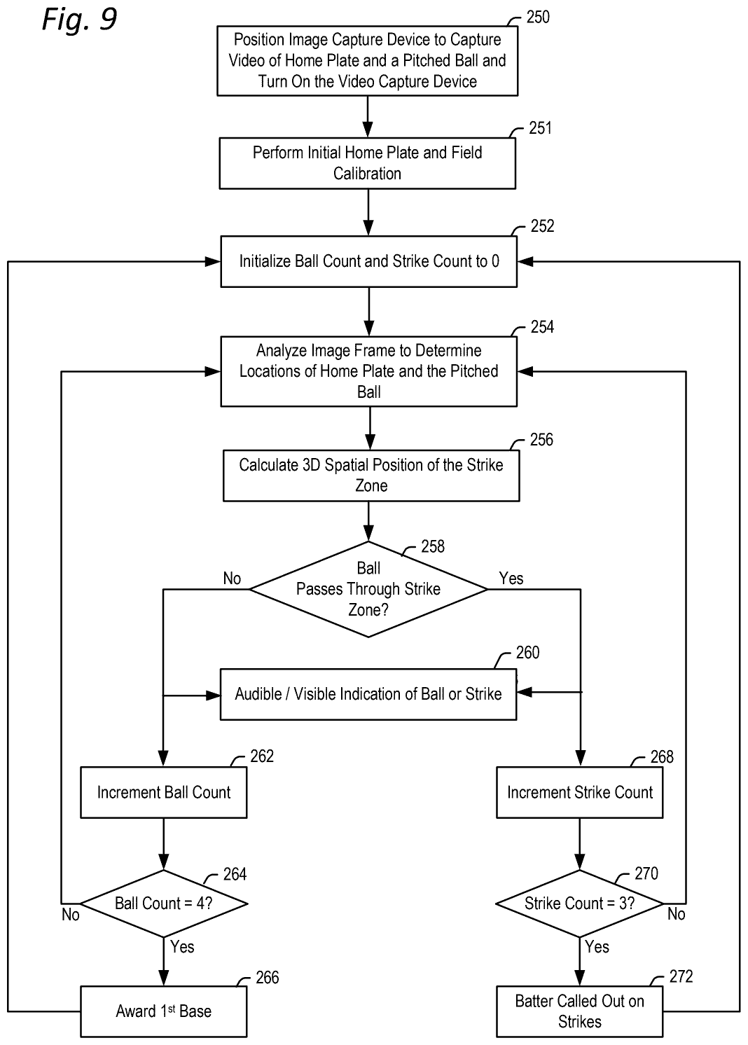

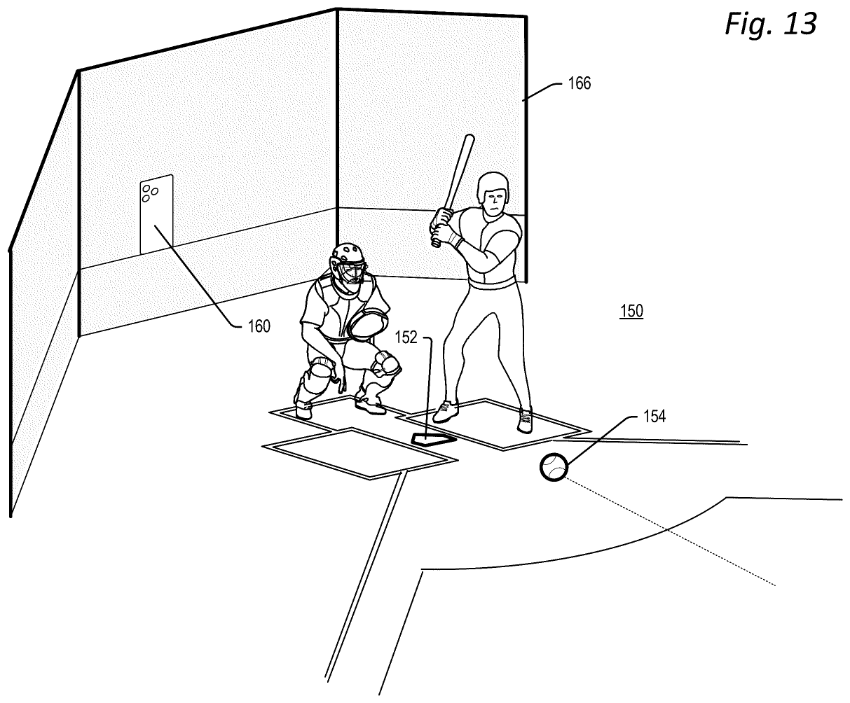

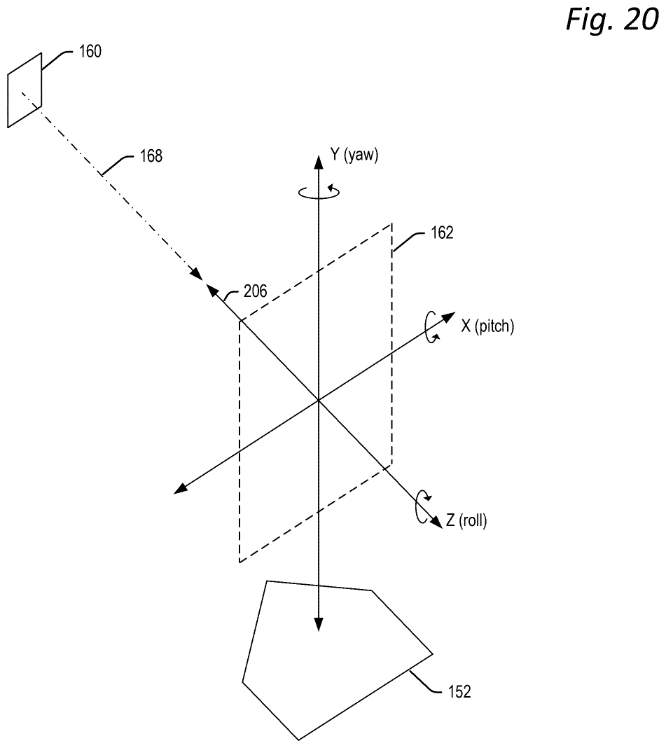

A second portion of the present technology involves implementation (or inference) of the trained MLM, or other artificial intelligence model, to detect one or more moving objects and one or more reference objects in a frame of video. The finished application used in the inference of the trained MLM, including for example BLU, will now be described with reference to the flow charts of FIGS. 9-12, and the images of FIGS. 13-27. In embodiments, the finished application may be used to identify a reference object (such as a home plate) and a moving object (such as a pitched baseball or softball) in one or more video frames captured from a baseball or softball game, and then use one or more algorithms to determine the relative positions of the reference and moving objects at a given instant in time. In the baseball and softball example, the finished application determines the relative position of a baseball or softball at a time when the ball crosses home plate to determine whether the ball is called a strike or a ball. These features are described in greater detail below. It is understood that the reference and moving objects may be a variety of other objects, from a variety of other sports or activities, in further embodiments, as is also described in greater detail below.

It is a feature of the present technology that the inference of BLU may be carried out by a single, off-the-shelf image capture device 160 (FIGS. 13-15) such as a single, standard iPhone. In general, image capture device 160 for inferring BLU may be any of a wide variety of commercially available, inexpensive devices including image capture and processing capabilities. These other devices include but are not limited to Android, Google and other mobile phones, still image and video cameras such as GoPro® mobile cameras, and laptops, iPads and other hand-held or mobile computing devices. Image capture device 160 may be identical to, or different from, the image capture device 110 for training BLU as described above. In some embodiments where the capture device 160 is an iPhone or iPad, the camera may include a so-called TrueDepth camera system from Apple.

In further embodiments, the device 160 may be a dedicated device, i.e., one that is dedicated to implementing the BLU application (explained below) to detect balls and strikes, and has no uses other than implementing the BLU application. In such embodiments, the device 160 may be permanently affixed at some or all fields where the present technology is implemented. At each field where the device 160 is permanently affixed, an optimal position may be selected, which optimal position may vary depending on the field.

In the embodiments where the image capture device 160 is a smart phone or a dedicated device, other secondary smart devices, e.g., smart phones, in the vicinity of device 160 or remote from device 160, may have a network connection to the device 160. Such secondary smart devices may for example receive the video feed from device 160. One or more such secondary smart devices may have some control functionality over the device 160, such as for example panning, zooming and/or controlling the device 160 to perform certain calibration steps as explained below. In a further example of a primary capture device 160 and one or more networked secondary devices, an umpire may capture a view of the field and a pitch (for example possibly on a helmet cam), and that view may be broadcast to other secondary devices which may also implement the BLU application on the video feed from the umpire's capture device.

In the above description, BLU is an example of a machine learning model used to identify a reference object (such as the home plate 152) and a moving object (such as the ball 154) in a captured image. The finished application implements BLU, as well as one or more other algorithms. These additional algorithms may include code for calculating a spatial position and orientation of a 2D or 3D strike zone from the identified home plate and other data. The finished application may further determine whether a pitched ball passes through the strike zone and identifies a pitched ball as a strike or a ball based on whether it passes through the strike zone. These additional algorithms may also include code for making certain 3D determinations regarding objects in the images captured by capture device 160. As described above, use of the name BLU refers to the machine learning model for identifying a home plate and ball in an image. As used herein, the term “BLU application” refers to the software application, routine and/or code which combines the inference of the BLU machine learning model with other algorithms such as for the calculation of the strike zone, whether a given pitch is a ball or a strike and/or 3D determinations of objects in captured images. The steps implemented by the BLU application, and in the use of the BLU application, will now be explained with reference to the flowchart of FIG. 9 and the views of FIGS. 13-27.

FIGS. 13-15 show a portion of a field 150 including a pitched ball 154 heading toward a home plate 152. In a first step 250, an image capture device 160 is positioned somewhere where it can capture video of both the home plate 152 and the pitched ball 154 and turned on to capture such video. As noted, it is a feature of the present technology that the BLU application is able to call balls and strikes in a baseball or softball game using a single, off-the-shelf mobile phone running the BLU application. It is a further feature of the present technology that the image capture device 160 does not need to placed in a single, precise position, but rather can be placed in any of a variety of convenient, user-defined positions. Convenient positions of the image capture device 160 in step 250 include for example affixed to different positions on a backstop 166 as shown in FIGS. 13-15, either to the left side, right side or directly behind home plate. When located on a backstop 106, the capture device 160 may be located anywhere on the backstop, behind the backstop or in front of the backstop, with a view of home plate 152 and pitches. When located in front of the backstop 106, the capture device 160 may be encased in a clear housing, for example made of plastic. As indicated above, where device 160 is a dedicated device, the device 160 may be permanently mounted at a given position.

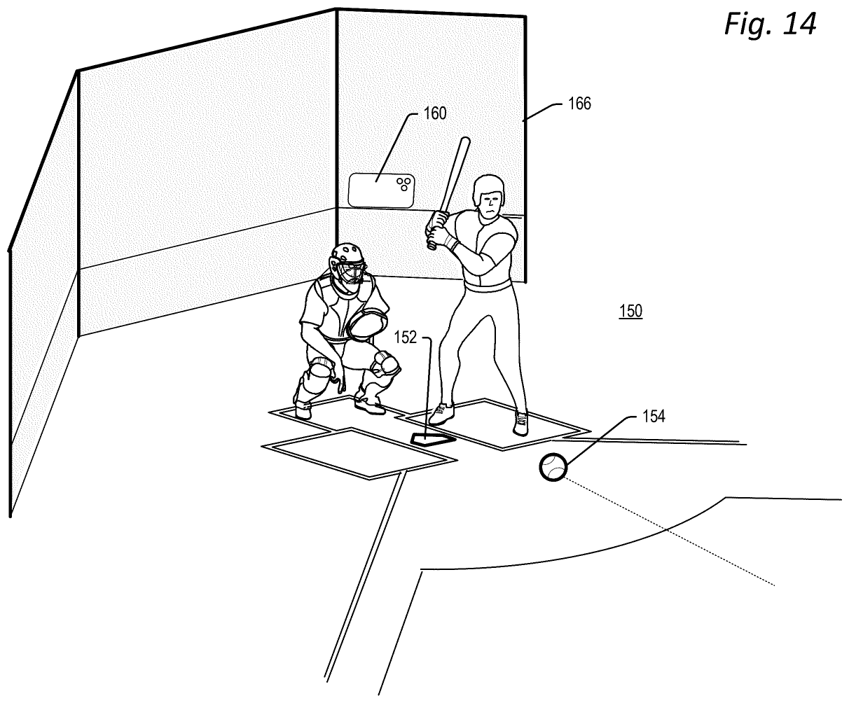

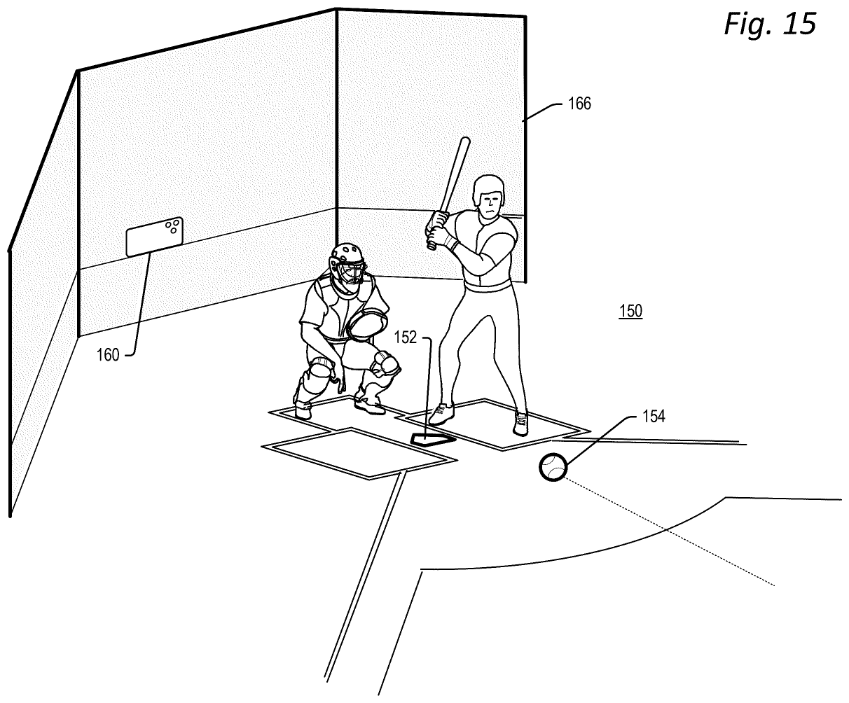

The device 160 may be oriented in a variety of orientations. One such orientation is vertical (FIG. 13) and another such orientation is horizontal (FIGS. 14 and 15), but other orientations between horizontal and vertical are possible. Moreover, while it may be convenient to place the camera 160 in one place and leave it there during a game, it is a feature of the present technology that the camera 160 may move during a game, and even during a pitch, and the present technology will still generate a ball/strike determination. This feature is explained in greater detail below.

Further still, while image capture device 160 is a mobile phone in embodiments, the image capture device may be other devices in further embodiments, including video cameras such a GoPro® camera. In such embodiments, the video camera may be stationarily mounted on a tripod or backstop as described above. Alternatively, the video camera may be mounted to the helmet worn by the catcher or umpire (if present). Such a video camera may be mounted in a protective harness on the helmet to prevent damage to the camera. In a still further embodiment, the mobile phone or video camera 160 may be affixed to a drone (not shown), traveling above the field 150 and capturing images of home plate 152 and a pitched ball 154.

While the capture device 160 may be placed, and remain, in a position having a view of home plate 152, it does not need to always have a view of home plate in further embodiments. In either case, the capture device 160 may undergo an initial calibration process (step 251) as will now be described.

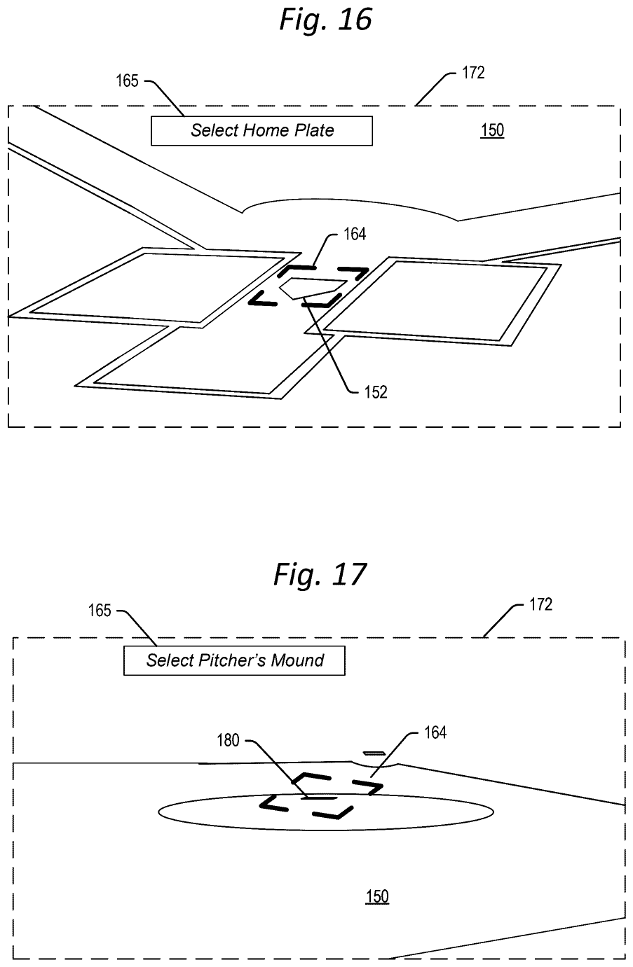

The calibration step 251 may initially have the BLU application identify home plate 152. In embodiments described above, BLU is trained to identify home plate 152 once appearing in the field of view of capture device 160. In a further embodiment, instead of (or in addition to) training BLU to identify home plate 152, the user may manually identify home plate 152 during the calibration process 251. FIGS. 16 and 17 are images 172 captured by the device 160. In embodiments, an object selection box 164 (FIG. 16) may be displayed on a screen of the image capture device 160, superimposed over image 172, and a graphical user interface (GUI) 165 presented by the BLU application may display a message to select home plate by placing the object selection box 164 over home plate. In particular, the object selection box 164 may for example appear in the center of the display, and the user can pan, zoom, etc., the captured image until the object selection box is centered over home plate 152. The GUI may then ask the user to confirm his/her selection. Current capture devices 160 are able to user vision algorithms to detect a plane of the field 150, so that the object selection box is displayed in that plane. Home plate 152 may be selected from an image 172 by other methods in further embodiments.

Once identified, by the trained BLU model or by selection as described above, the position of home plate 152 may be stored. This position is fixed and known in a defined frame of reference, independent of the position of the capture device 160. Thereafter, the BLU application knows the position and orientation of home plate 152 even if the capture device 160 is moved and/or its view of home plate 152 is blocked. Moreover, the stored position of home plate 152 may be used to automatically recognize home plate 152 in future uses of the BLU application at that particular field (that field may be said to be “BLU enabled,” or “BLU calibrated”).

The calibration step 251 may further include identification of the pitcher's mound. In baseball, the mound is typically a raised crown on the field. However, in baseball or softball, the mound may not be raised. It may only be a plastic (or other material) block from which the pitcher starts the pitch. It may only be a line drawn on the field from which the pitcher starts the pitch. Each of these is considered a ‘pitcher's mound’ as used herein.

As shown in FIG. 17, the user interface may again display the object selection box 164 and the user may be prompted to select the pitcher's mound 180 via the GUI 165. The above steps for selecting and storing a position of home plate 152 may be repeated for selecting and storing the position of the pitcher's mound 180. Instead of or in addition to recognizing the pitcher's mound 180 using the object selection box 164 as described above, BLU may be trained to recognize the pitcher's mound as mentioned above.

Instead of, or in addition to, identifying the pitcher's mound 180 as described above, the BLU application may recognize a pitcher on the pitcher's mound, and use that to define the position of the pitcher's mound. BLU may be trained to recognize pitchers (i.e., the throwing motion toward home plate). Alternatively or additionally, the capture device 160 implementing the BLU application may have the ability to recognize a person, features of a person and/or pose information. This recognition may then be used to set the position of the pitcher's mound.

The calibration step 251 may further include mapping of the rest of the baseball field based on the determined fixed positions of home plate 152 and the pitcher's mound 180. In particular, the relation and distances of each of the bases to home plate 152, the pitcher's mound 180 and each other is known. Thus, the BLU application is able to map out the rest of the field, including positions of first base, second base, third base and the fair/foul lines. The field may be oriented about a vector through home plate and the pitcher's mound. The field may be oriented by positioning second base along this vector. With those two defined (home plate, pitcher's mound and second base), the position of the rest of the field is known.

Different fields have different sizes, depending on the sport (baseball or softball), and depending on age level (little leagues have a smaller field than high schools). In order for the BLU application to properly calibrate the field, it needs to know the sport and level of the game in which the BLU application is to be used. This information may be entered by a user through a user interface to the BLU application on capture device 160. In further embodiments, users may manually enter the field dimensions and then the BLU application is able to map out the field.

Most modern-day image capture devices have image processing algorithms for automatic lens distortion correction. However, where an image capture device 160 does not include automatic lens distortion correction, the calibration step 251 may further implement known techniques for compensating for lens distortion, such as for example capturing images of a checkerboard with equal size squares. The BLU application may then analyze the captured images and correct/calibrate the image capture device to compensate for lens distortion.

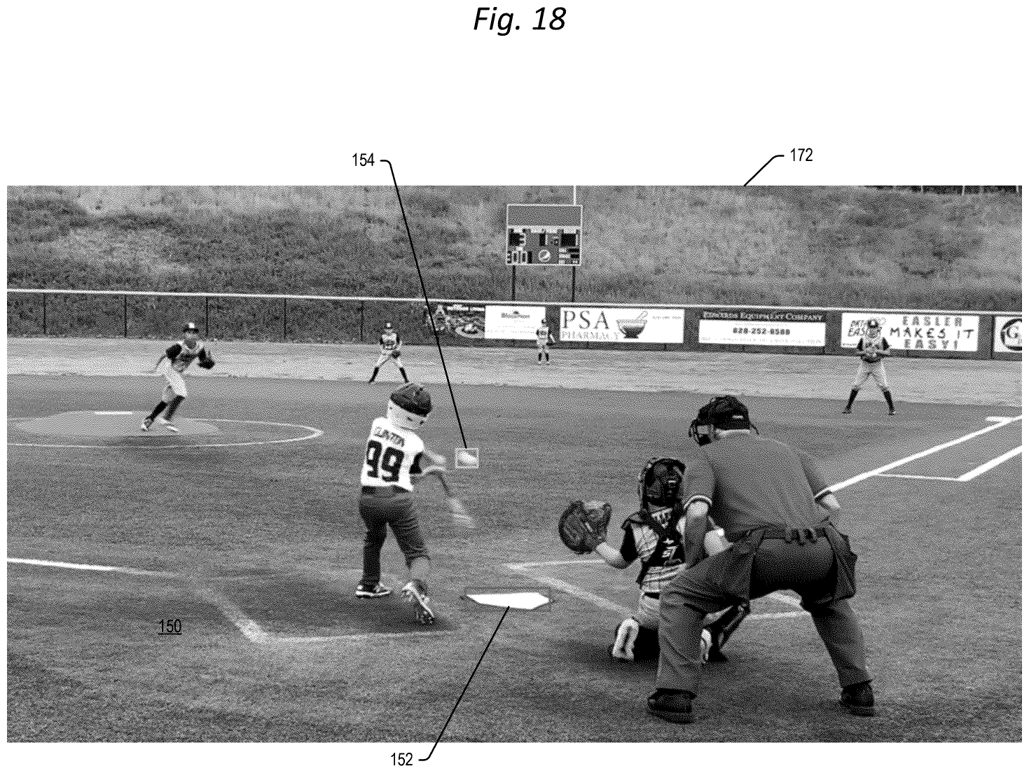

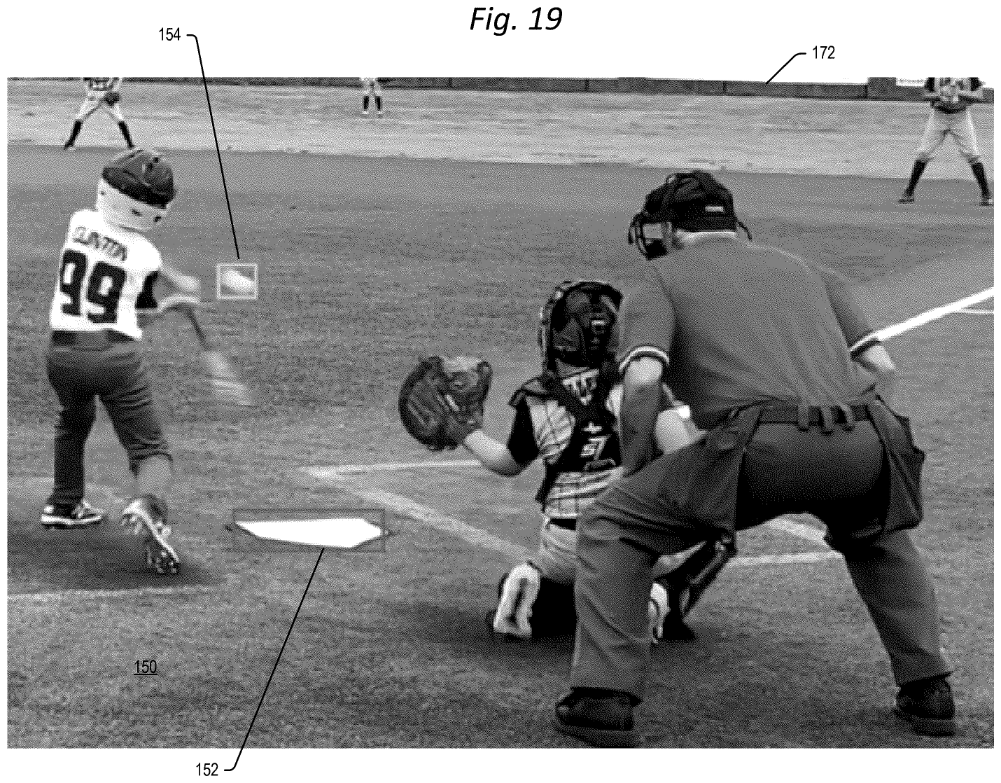

In step 252, a ball count and a strike count are initialized to 0. As explained below, these counters are reset for each batter. In step 254, individual image frames from the video captured by the device 160 are analyzed by BLU to identify home plate 152 and ball 154 in each such image frame, as well as their position within each such image frame. FIG. 18 is an image 172 captured by the device 160. FIG. 19 is an enlarged view of a portion of FIG. 18. BLU has identified home plate 152 (highlighted in a box) and the ball 154 (also highlighted in a box). It is a feature of the present technology that BLU has been trained as explained above to identify the position of home plate 152 and ball 154 in image frames under any of the wide variety of conditions which may exist during a baseball or softball game. For example, as seen in FIG. 19, given the speed of the moving ball 154, the ball 154 appears as an oddly shaped blurred object. However, BLU has learned to identify the ball even with such an appearance in an image 172.

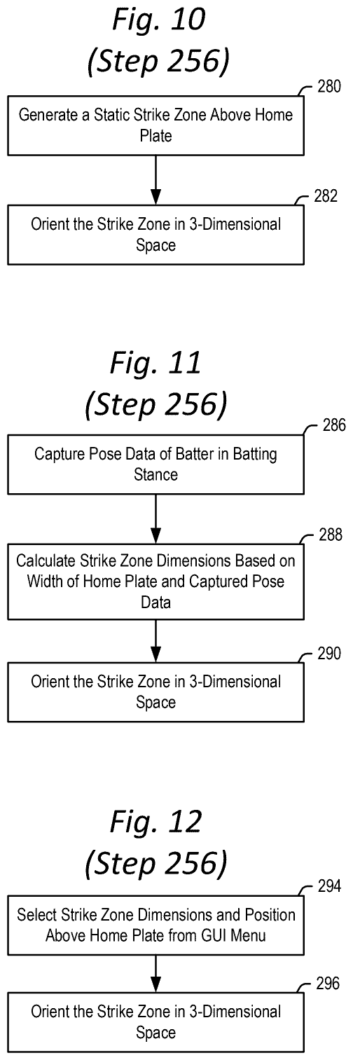

In step 256, the BLU application calculates a spatial position, orientation and dimensions of a strike zone at least from the position of home plate 152. Further details of step 254 for calculating a position, orientation and dimensions of the strike zone will now be explained with reference to the flowcharts of FIGS. 10-12.

In a simple embodiment described in the flowchart of FIG. 10 and the illustration of FIG. 19, the BLU application may generate a static, 2D strike zone 162 in a vertical plane above home plate 152 in step 280. In this embodiment, the strike zone 162 may be a predefined length and width, positioned at a predefined height above home plate 152. For example, the strike zone may be set in a vertical plane at 17 inches wide (the conventional width of home plate 152), with a bottom border 20 inches above home plate and a top border 42 inches above home plate. These dimensions may vary in further embodiments.

In step 282, the 2D strike zone 162 may be oriented in 3D space. The ability of the BLU application and capture device 160 to understand 3D space is explained below. Referring to FIG. 17, the strike zone 162 may be oriented in a vertical plane about the pitch (x) axis. The top and bottom borders of the strike zone may reside in horizontal planes about the roll (z) axis.

As for the yaw (y) axis, in a simple embodiment, the home plate 152 and strike zone 162 may be oriented to “look at” the pitcher's mound. In particular, as noted above, during the calibration step 251, the positions of home plate 152 and pitcher's mound 180 may be determined. Using various features of image capture device 160, machine vision algorithms, monocular depth sensing MLMs and/or heuristic techniques explained below, the BLU application is able to construct a 3D coordinate system of field 150, including the position of the pitcher's mound 180, home plate 152 and, accordingly, strike zone 162. Many image capture devices 160 are able to implement code directing a first object defined in 3D space to look at, or face, a second object in 3D space. Thus, in one embodiment, the yaw axis may be set by code directing the home plate and strike zone to look at, or face, the pitcher's mound.

In a further embodiment (where for example image capture device 160 does not include the “look at” functionality), a vector 168 may be calculated from the image capture device 160 to home plate 152, and the strike zone 162 may be oriented orthogonally to this vector about the yaw axis. Unless the capture device 160 is directly behind home plate, this method of calculation will introduce some error in the orientation about the yaw axis, but this error may be negligible.

In a still further embodiment for calculating the yaw axis, BLU may be trained to identify the distance and offset angle between the camera 160 and home plate 152 as explained above. Using this information, the proper orientation of the strike zone 162 about the yaw axis may be calculated. For example, where the reference line, RL (FIG. 8), is located straight back from home plate, the known offset angle of the camera 160 from the reference line is known, and the yaw axis of the strike zone 162 may be oriented orthogonally to the reference line.

In a further embodiment for calculating yaw orientation, instead of using the information from the calibration step 251, a vector may be calculated from a starting position of a pitched baseball (as it leaves the pitcher's hand) to home plate, and the strike zone 162 may be oriented about the yaw axis orthogonally to this vector. The position of the baseball as it leaves the pitcher's hand may be identified from an image frame captured by the device 160 and determined by BLU.

The flowchart of FIG. 11 describes a further embodiment for defining the size and position of a 2D strike zone 162, where the size and position of the zone may vary based on the size of a batter. In step 286, pose data of a batter is captured to identify a height of the batter's knees, waist and/or shoulders above a reference plane (i.e., the ground) when in his or her batter's stance before each pitch. Pose identification algorithms are known which are able to identify these pose points in real time within each individual image frame.

In step 288, using the pose data determined in step 276, the size and position of the strike zone 162 above plate 152 may be calculated. In one example, the strike zone in this embodiment may be 17 inches wide (the width of home plate 152). The bottom border of the strike zone 162 may be the height above the ground of the batter's knees when in his or her stance. The top border of the strike zone 162 may be a midpoint between the batter's waist and shoulders above the ground when in his or her stance.

A batter may change his or her stance as a pitch travels. As such, in this embodiment, the length of the strike zone 162, and the height of the strike zone above home plate 152, may vary each image frame, and may be recalculated each image frame. The strike zone to be used for the ball/strike determination may be the strike zone calculated at a beginning of a pitched ball 154, an end of the pitched ball 154 when it crosses home plate 152, any image frame therebetween, or some average of the strike zones calculated between the beginning and end of a pitched ball.

Pose (and other) data may be used in different ways to determine the dynamic strike zone according to this embodiment. For example, instead of measuring knee, waist and shoulder height in the batting stance, the pose data may measure only knee and shoulder height when in the batting stance to determine the strike zone. In further embodiments, pose data may be captured of the user's knees, waist, shoulders and/or total height while standing. The height and position of the dynamic strike zone may then be determined based on the height of the user's knees, waist, shoulders and/or total height while standing. For example, height above ground may be some percentage of the batter's overall height, and the length of the zone may be some percentage of the batter's overall height.

In a further embodiment, overall height data of a batter may be identified not using pose data. For example, a database of all players may be maintained, which database also includes player height. A batter line up is submitted before a game, so the BLU application can keep track of which batter is at the plate. Alternatively, BLU may use image data to identify batters. When a given batter is up, the BLU application can retrieve that batter's height from memory and use that to determine the dynamic strike zone as indicated above. The dynamic strike zone may be determined other ways in further embodiments. In step 290, an orientation of the strike zone 162 may be determined as described above.

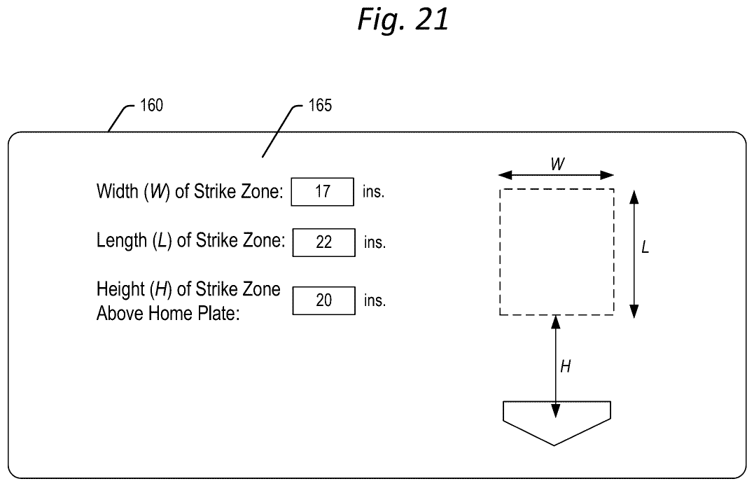

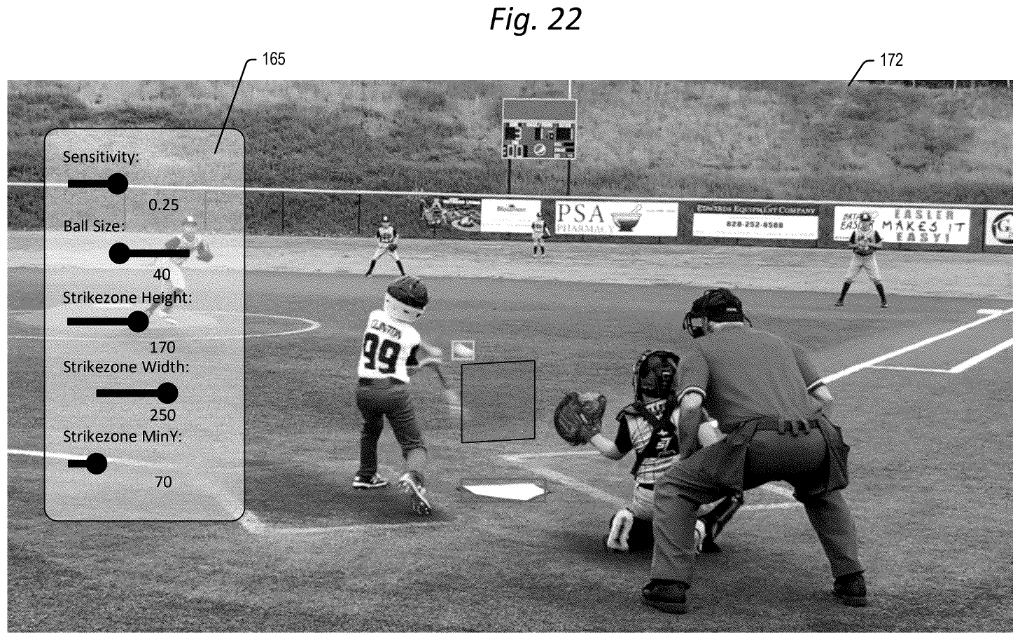

The flowchart of FIG. 12 describes a further embodiment for defining a spatial position of a 2D strike zone 162, where the size and position of the zone may be manually set by a user of the BLU application. In step 294, using a menu displayed on GUI 165, a user may manually select the length and width of the strike zone 162, as well as the height of the strike zone 162 above home plate 152. FIGS. 21 and 22 show examples of the GUI menu 165 with which a user may interact to make these selections. In FIG. 21, a user may enter specific dimensions (width, length, height above ground) of the strike zone 162. FIG. 22 shows a GUI 165 overlayed onto a video image 172 captured by device 160. In the embodiment of FIG. 22, a user may use a graphical slide scale to set the dimensions and position of the strike zone 162. It is understood that GUI menu 165 may have a wide variety of other appearances, each providing the user with options for making the above selections. In one further embodiment, instead of a slide scale, a box with a “−” on one side and a “+” on the other may be presented for each parameter to be set. The user may then decrease or increase the given parameter within such a GUI 165 by tapping on the “−” or “+”, respectively. Thus, the screen may present the parameter “strike zone height. The strike zone height may then be increased by tapping the “+” or decreased by tapping the “−”. These selections may be made once for multiple batters, once for each batter, or multiple times per batter. In step 296, an orientation of the strike zone 162 may be determined as described above.

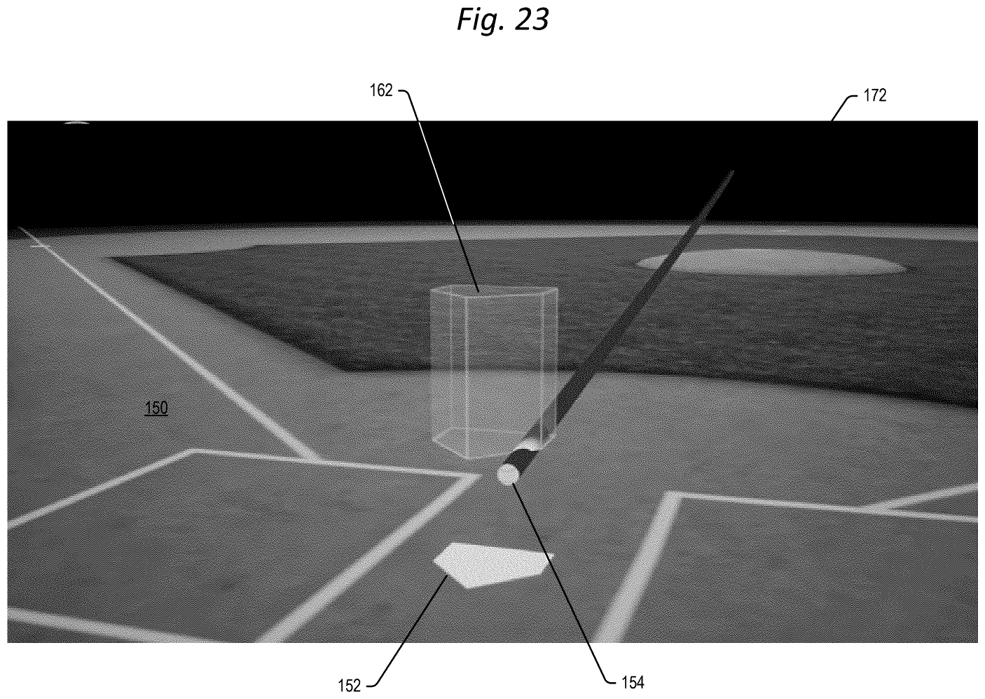

In embodiments described above, the strike zone 162 may be a 2D rectangle within a vertical plane as described above. It may be positioned at a front of the home plate 152, in a middle (front to back) of the home plate 152 or in other vertical planes. In further embodiments, the strike zone 162 may be a 3D volume. Such an embodiment is illustrated in FIG. 23, which shows an image 172 captured by device 160 including a graphical representation of the 3D strike zone 162. The length of the strike zone 162 and the height of the strike zone 162 above the plate 152 in this embodiment may be calculated per any of the above-described embodiments. The cross-sectional shape of the strike zone (in a horizontal plane) may match the shape of home plate 152. In this embodiment, a pitched ball 154 entering any portion of the 3D space may be identified as a strike.

Returning again to the flow chart of FIG. 9, after calculation of the spatial position and dimensions of the strike zone in step 254, the BLU application may next determine in step 258 whether one or more image frames indicate that the ball 154 passes through the strike zone 162. This may be detected at least one of two ways. A first way is to capture a video frame showing the ball 154 occupying the same vertical plane as the strike zone 162 for a 2D strike zone, or showing the ball 154 occupying any of the planes of a 3D strike zone. If the ball 154 in this image frame intersects any portion of the strike zone 162, then the pitch is a strike (ignoring for the moment whether the batter swings). Conversely, if the ball 154 in this image frame does not intersect any portion of the strike zone 162, then the pitch is a ball (again, ignoring for the moment whether the batter swings).

Depending on video frame rate, it may happen that a ball does not appear in the video frame where it passes through the plane of home plate (less likely when home plate is 3D, but still possible). In this event, a second way of calculating whether a ball passes through the strike zone is for the BLU application to examine earlier image frames of the same pitch, determine a position of the ball 154 in each such earlier frames, determine a flight path (trajectory) of the ball 154 from such earlier frames, and then interpolate a position of the ball when it passes through the strike zone 162 based on its calculated flight path. Different pitches follow different trajectories, so examining multiple such earlier image frames may increase the likelihood of a correct interpolation of ball position as it passes through the strike zone 162.

Examining a number of successive image frames to interpolate whether a ball on the current path (curved or straight) will pass through the strike zone in a future image frame may also be used as a double check on the ultimate determination. This can improve the accuracy of the BLU application.

Depending on the vantage point selected for the image capture device 160, a view of home plate 152 may be partially or fully blocked by the catcher and (when present) the umpire. However, as described above, the position of home plate 152 may be determined for example during the calibration step 251 and stored. Thus, the BLU application is able to construct the strike zone 162 even if a view of home plate 152 is partially or fully blocked.

In step 260, the BLU application gives an audible and/or visible indication as to whether the pitched ball 154 is a ball (does not pass through the strike zone) or a strike (does pass through the strike zone). The BLU application keeps track of the batter count (total balls and strikes). As noted above, at the beginning of an at bat, the ball count and strike count are both initialed to 0. If a pitch is a ball, the ball count is incremented by 1 in step 262. In step 264, the BLU application determines if the ball count has reached 4. If so, the batter is awarded first base in step 266. The flow returns to step 252 where the ball and strike counts are re-initialed to 0 and the process repeats for the next batter. If not yet ball 4, the flow returns to step 254 to analyze the next pitch.

If instead a pitch is a strike in step 258, the strike count is incremented by 1 in step 268. In step 270, the BLU application determines if the strike count has reached 3. If so (ignoring for the moment the rules related to a dropped third strike by the catcher), the batter is called out on strikes in step 272. The flow returns to step 252 where the ball and strike counts are re-initialed to 0 and the process repeats for the next batter. If not yet strike 3, the flow returns to step 254 to analyze the next pitch.

The above-described steps of the flowchart of FIG. 9 are performed for each video frame captured, for example 60 times a second (with the exception of step 250, positioning the capture device 160, which may be performed once at the initiation of video capture). One advantage of running through the steps of FIG. 9 each video frame is that the image capture device 160 may be moving, even during a pitched ball. This allows for embodiments where the image capture device 160 is mounted to a helmet of the catcher or (when present) the umpire. It also allows the image capture device to be hand-held or mounted on a drone hovering over the field. In further embodiments, the flow of FIG. 9 may be performed only in periodic video frames.

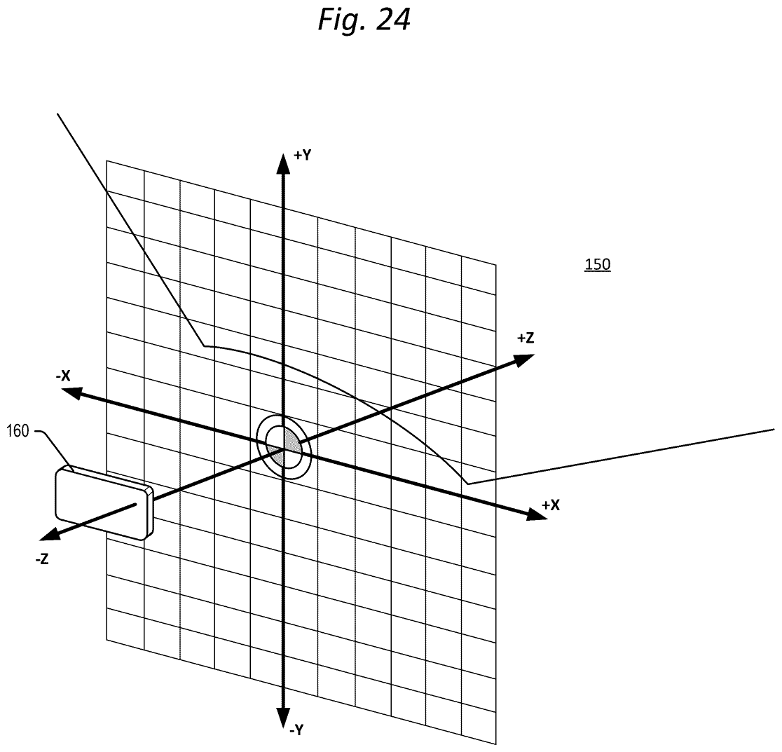

FIG. 24 is an illustration of an arbitrary 3D reference frame which may be used to describe the real world positions on the field 150, such as home plate 152, the pitcher's mound 180, the other bases and foul lines. In this example, the x, y and z axes are defined by the orientation of the image capture device 160. In particular, the z-axis extends straight out from the capture device 160, and the x-y plane is perpendicular to the z-axis. The x-axis may be horizontal and the y-axis may be vertical. The field 150 resides in the x, z plane. It is understood that the 3D space of the field 150 may be defined by other reference frames in further embodiments. Moreover, known matrices may be used to translate coordinates in the reference frame of FIG. 24 to other reference frames.

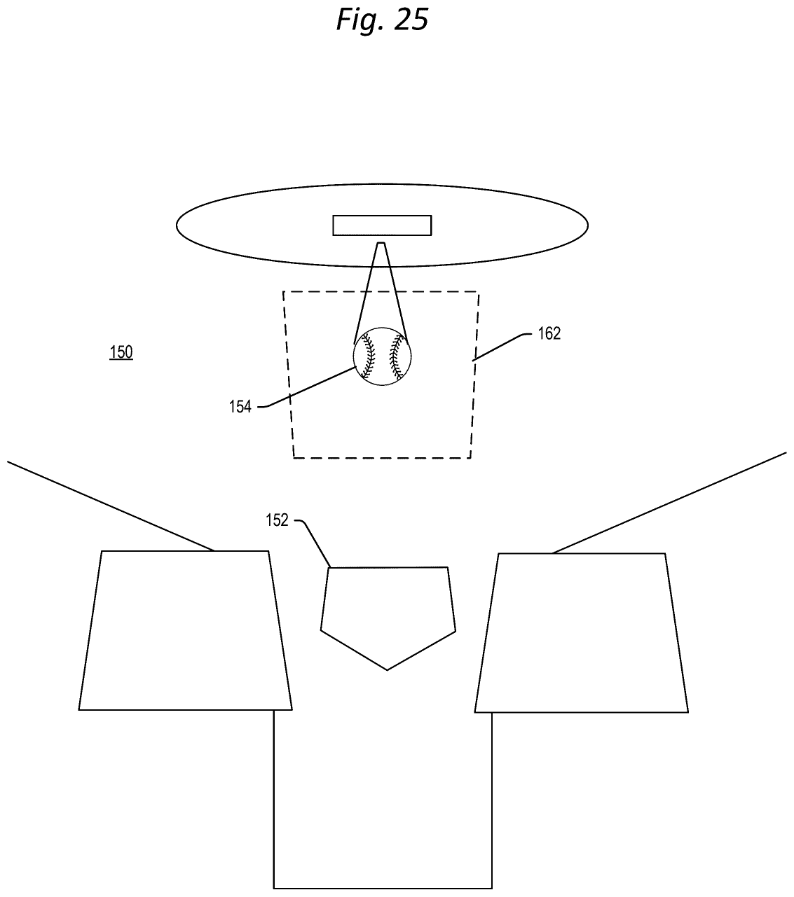

It has been determined through experimentation that it is necessary or at least helpful for the BLU application and/or camera 160 to make certain 3D determinations of objects it detects. If not 3D, it is necessary or at least helpful for camera to make certain depth determinations in the x, z plane, including straight out from the camera. This need is illustrated in FIG. 25. FIG. 25 is a view captured by capture device 160, for example from the perspective shown in FIG. 15, and at the same instant in time as the view shown in FIG. 15. As seen in FIG. 15, the ball 154 is approaching home plate 152, but has not yet reached home plate. In the image capture of this event in FIG. 25, the BLU application has detected home plate 152, and constructed the strike zone 162 as described above. A problem arises in that the ball 154 in FIG. 25 appears to be inside the strike zone 162, and, unless the BLU application is able to make depth determinations along the z-axis, the ball 154 shown in FIG. 25 would be called a strike even though the ball has not yet reached home plate 152 or the strike zone 162.

Therefore, in accordance with further aspects of the present technology, this problem is solved by determining and using depth measurements along the z-axis. The image capture device 160 may employ various techniques for making such depth measurements. These techniques include hardware provided within the image capture device, machine vision algorithms implemented as part of the BLU application (or native to the capture device 160), monocular depth sensing MLMs, and/or heuristic techniques which make use of known features of the field and objects to make determinations of depth along the z-axis. Examples of each of these techniques are provided below. As the image capture device 160 is capable of making 3D determinations, including along the z-axis, the image capture device 160 may also be referred to herein as a 3D enabled image capture device.

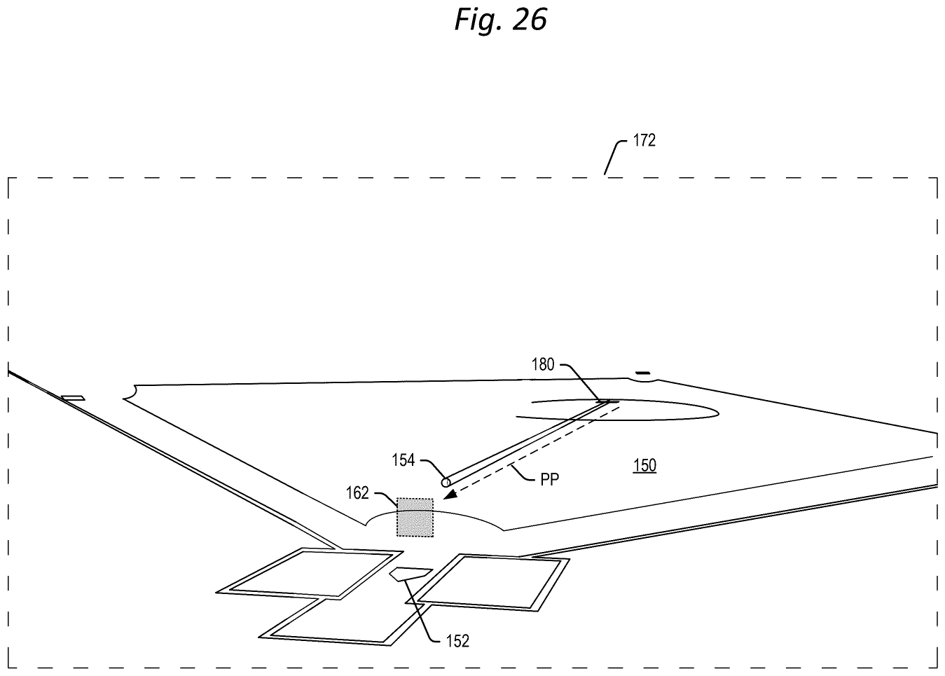

Referring now to the view of a captured image 172 shown in FIG. 26, where image capture device 160 is a 3D enabled capture device, the image capture device 160 is able to determine, in each frame of captured video, the 3D position of the ball 154 along a pitch path, PP, between the mound 180 and home plate 152. This position includes a z-axis depth component given by the distance between the capture device 160 and the ball 154 at the time the image is captured. Using the 3D determination made by the BLU application, the BLU application is able determine when the pitched ball 154 has reached the vertical plane including the strike zone 162 so that it may, at that time, detect whether the pitched ball intersects with the strike zone (and is a strike) or whether the pitched ball has missed the strike zone (and is a ball).

In embodiments, the BLU application is able to determine 3D position of the ball and other objects in the field of view each image frame using hardware on the capture device 160. For example, some 3D enabled capture devices include multiple lenses that together are able to determine z-axis depth to objects in the field of view using binocular disparity. In further embodiments, the image capture device 160 may include LIDAR (light detection and ranging) capabilities, or other time-of-flight capabilities which use light pulses to measure the distance to objects within the field of view. In further embodiments, the image capture device 160 may include TrueDepth capabilities enabling the camera to build a depth map of a captured scene. The capture device 160 may include other hardware enabling 3D determinations in further embodiments.

Some 3D enabled devices include machine vision algorithms to determine depth to an object such as ball 154. These machine vision algorithms may include, but are not limited to, depth from defocus (DfD), structure from motion (SfM), homography estimation, and/or keypoint matching using for example scale-invariant feature transform. These techniques are known, but in general, DfD can estimate the depth to objects such as a ball 154 captured in an image frame by analyzing the amount of blur in the image relative to the focus setting of the camera and comparing it to the known spacing of the bases and/or dimensions of the baseball field 150. SfM can estimate the depth to ball 154 by analyzing its movement across a sequence of images capture device 160 to infer 3D structure based on the known spacing of the bases and/or dimensions of the baseball field 150. Homography can be used to estimate the depth to baseball 154 by mapping the image coordinates of the baseball 154 and other portions of the captured image to the known spacing of the bases and/or dimensions of the baseball field 150, and using a transformation matrix, it can infer the relative position and depth based on perspective distortions and the known geometry of the scene. Keypoint matching using SIFT can estimate the depth to a baseball by identifying and matching distinctive features of the baseball across multiple images or frames, then calculating the change in position relative to known reference points in the baseball field. By analyzing these matched keypoints and their relative scales, the depth can be inferred based on the known spacing of the bases and/or dimensions of the baseball field 150 and the geometry of the scene. It is understood that other machine vision algorithms may be used to detect and identify key features of the field such as home plate, the bases and/or the foul lines and determine depth to the ball 154 and other features in further embodiments.

In further embodiments, the image capture device may implement a machine learning model (as part of BLU or separate from BLU) that is trained to measure depth to objects within an image captured by the image capture device. Such monocular depth sensing MLMs are trained on large datasets to infer or otherwise determine depth to objects within a captured image. These monocular depth sensing MLMs are trained using a variety of visual cues, including for example object occlusion, convergence of parallel lines toward the horizon, shading and lighting, perceived motion of objects in successive image frames, and aerial perspective where objects appear hazier due to the greater influence of scattered light by the atmosphere with greater distances.

In accordance with further aspects of the present technology, the BLU application may detect z-axis depth and 3D positions to moving and reference objects in a field of view of image capture device using heuristic techniques. These heuristic techniques that make use of known parameters of the ball 154 and field 150 including home plate, the bases and/or the foul lines to make depth and 3D determinations.

One such heuristic technique makes use of the fact that, where the capture device 160 is positioned somewhere behind home plate (to the left, right or centered), the size of the ball 154 will get larger in a captured image the closer it gets to home plate. Thus, by identifying the ball 154 in successive image frames, and then tracking the increasing number of pixels of the ball 154 in successive frames, the BLU application can determine changes in the depth of the ball, and the absolute depth of the ball 154. As the position of home plate is known, the BLU application can determine when the ball crosses home plate (or a vertical plane including home plate).

In further embodiments, the percentage change in the perceived size of the ball may be determined in successive frames, based on measuring pixels. Given the known distance between the pitcher's mound and home plate, BLU can determine that the ball is crossing a vertical plane of home plate when the perceived size of the ball has enlarged by some predetermined percentage from the first image frame capturing a pitched ball.

Another heuristic technique makes use of the known distance between home plate 152 and the pitcher's mound, and the motion of the ball 154 appearing in successive frames of video captured at a known frame rate. Upon detecting the position of the ball 154 in successive frames passing at a known frame rate, the BLU application is able to determine a velocity of the ball. With the known velocity of the ball 154 and the known distance to home plate 152, the BLU application can determine the time and corresponding frame at which the ball 154 will pass through the vertical plane including the strike zone 162. Given the forces of wind, friction and other environmental conditions, the ball may slow down as it approaches home plate (or speed up depending on wind direction). This positive or negative acceleration may also be discerned by examining the position of the ball 154 in successive image frames capturing the ball, and factored into the calculation of the time and corresponding frame where the ball arrives at home plate 152. The image capture device 160 may also have sensors for sensing wind and other environmental conditions which feedback may be used to hone the determination of the time and frame where the ball will cross home plate.

In a still further heuristic technique for determining a depth measurement of the ball 154 as it travels toward home plate is to make use the positions of objects in an image frame and map them to the known positions of the objects in the 3D world. For example, the positions of home plate, the pitcher's mound and the bases are known relative to each other. By detecting the apparent positions of these objects from the 2D image frames, these 2D positions in the image frames may be mapped to 3D positions of the objects in the real world. Using this mapping, the apparent position of the ball 154 relative to these objects in the image frames may be mapped to the real world to allow inference of the position of the ball as it travels toward home plate. As noted above, the BLU application may be trained to recognize the offset position and distance between home plate and the image capture device 160. This information may also be used in the above heuristic techniques to assist in determining the position of the ball 154 in 3D including depth along the z-axis.

The present technology may make use of additional heuristic techniques to determine that an object captured by the image capture device 160 is not a ball 154. For example, as explained below, the present technology may construct a region of interest such as a pitch tunnel encompassing an area on the field between the pitcher's mound and home plate which might include a pitched ball. Any objects outside of this area of interest may be ignored. The area of interest may be a 3D object as explained below. The area of interest may alternatively be a 2D region taken from a captured image.

Another heuristic technique to rule out what is not a pitched ball may examine the trajectory and/or ball size of a pitched ball in successive image frames of captured by device 160. For example, after 2, 3 or more image frames, the BLU application is able to determine a trajectory of the ball as it approaches home plate. This may be a straight line or it may be a curved or parabolic line. In either case, the BLU application is able to determine this trajectory, and/or describe this trajectory in mathematical terms, so that it can interpolate future positions of the ball 154 as it approaches home plate. Any object captured in an image frame that deviates from this interpolated future position of the ball more than some predetermined margin for error in the calculation can be ruled out as a ball 154 and ignored.

Similarly, as described above, the size of the ball in pixels increases as it approaches home plate. This change in size over time (in successive image frames) will be relatively constant as it approaches home plate. Thus, in the same way as position, the BLU application is able to determine this change in size so that it can interpolate future sizes of the ball (as a total number of pixels captured pixels) as it approaches home plate. Any object captured in an image frame that deviates from this interpolated future size of the ball more than some predetermined margin for error in the calculation can be ruled out as a ball 154 and ignored.

It is understood that one or more of the above-described hardware features, machine vision algorithms, monocular depth sensing MLMs and/or heuristic techniques may be used together to determine the position of the ball in 3D and in particular, when it crosses the plane of the strike zone 162. Some of the above-described machine vision algorithms may be native to the operating systems of certain image capture devices. For example, recent releases of the iPhone include functions such as Projectpoint and Unprojectpoint which use depth determinations along the z-axis to convert 2D image points to 3D world coordinates and vise-versa. As used herein, determining the 3D position and/or depth along the z-axis includes estimation and inference of the 3D position and/or depth along the z-axis.

It is further understood that various mathematical equations and matrices may be used to identify positions of objects such as a pitched ball 154 in an image frame and translate those identified positions into 3D coordinates. This method may for example use the captured positions of objects in a 2D image frame, and the known positions of these objects and/or the known positions of objects relative to each other in 3D space, to determine the mathematical equations and/or transformation matrices to transfer the 2D positions of the ball into 3D space. For example, the positions of home plate, the pitcher's mound, the bases and/or the foul lines are all known relative to each other in 3D space. Using the captured images of two or more of these objects from an image frame, the mathematical equations and/or transformation matrices may be determined that allow transformation of an object (i.e., the ball 154) captured in a 2D image into a position of the ball in 3D space (and vice-versa). Using the transformed positions of the ball, it can be determined when the ball 154 passes through a plane including home plate in 3D space, and whether the ball at this time is inside or outside a calculated strike zone.

Further, from Apple's development ecosystem, raycasting is a technique which can be used with the present technology to determine depth data using frameworks such as SceneKit and ARKit. SceneKit is a framework for rendering 3D graphics. It provides methods for performing raycasting to interact with 3D objects in a scene. For example, SCNSceneRenderer's hitTest(_: options:) method can be used to perform raycasting and find objects in a 3D scene that intersect with a ray. ARKit combines device motion tracking, camera scene capture, and advanced scene processing to enable augmented reality experiences. ARKit allows developers to use raycasting to find real-world surfaces and objects from the device's camera feed. For instance, ARSession's raycast(_:) method can be used to cast a ray from the camera into the real world and detect intersections with detected surfaces or feature points.

Some additional methods which may be used by the present technology to determine depth data are disclosed in articles for example on the Apple developer platform. These articles include “Capturing Photos with Depth”—https://developer.apple.com/documentation/avfoundation/additional_data_capture/cap turing_photos_with_depth. In general, this article discloses that, on iOS devices with a back-facing dual camera or a front-facing TrueDepth camera, depth information can be captured alongside photos to create effects like Portrait mode. A depth map indicates the distance from the camera to different parts of the image, allowing for image processing that distinguishes between foreground and background elements.

Developers can enable depth capture by configuring the appropriate camera device and photo output settings in their capture sessions. The depth data can be immediately used for effects or saved for later use, with dual camera systems providing relative depth accuracy and TrueDepth cameras offering absolute depth accuracy.

Another Apple developer article that discloses techniques that can be used to determine depth according to the present technology is “Capturing depth using the LiDAR camera.”—https://developer.apple.com/documentation/avfoundation/additional_data_capture/cap turing_depth_using_the_lidar_camera. That article discloses that with certain versions of the iOS operating system, developers can use the LiDAR camera on supported devices to capture high-precision depth data, ideal for applications like room scanning and measurement. The sample code project demonstrates how to capture and render depth data from the LiDAR camera in both streaming and photo modes. It involves configuring the LiDAR camera, setting the appropriate video and depth formats, and using AVCaptureVideoDataOutput and AVCaptureDepthDataOutput for streaming synchronized video and depth data. For photo capture, AVCapturePhotoOutput is used to capture photos with depth data, which can then be processed and displayed using Metal-based visualizations.

A further article disclosing techniques that can be used with the present technology is “Streaming Depth Data from the TrueDepth Camera”—https://developer.apple.com/documentation/avfoundation/additional_data_capture/stre aming_depth_data_from_the_truedepth_camera. That article in general discloses that the TrueDepth camera on iOS devices provides real-time depth data, allowing developers to determine pixel distances from the front-facing camera. This sample project demonstrates how to use AVFoundation to capture and visualize depth data in 2D and 3D. The 2D view uses JET color coding to map depth values to colors, while the 3D view renders data as a point cloud, allowing users to interact with the visualization through gestures. The setup involves configuring an AVCaptureSession to capture both video and depth data, and synchronizing these outputs. The project includes methods to handle the thermal state of the device, ensuring it does not overheat during intensive depth data processing.

Another article including information which can be used to determine depth according to the present technology is “Creating Auxiliary Depth Data Manually”-https://developer.apple.com/documentation/avfoundation/additional_data_capture/creating_auxiliary_depth_data_manually. That article discusses iOS portrait mode and that the portrait mode generates depth maps and attaches them as auxiliary metadata, but for custom effects, auxiliary depth images can be created manually. This process involves converting grayscale pixel values to either depth or disparity in a compatible floating-point format (like DepthFloat16 or DepthFloat32), and then loading the grayscale image into a CVPixelBuffer. The pixel buffer data is then passed into a CFDictionary, formatted according to specifications in CGImageSource.h. This dictionary includes keys for depth data, description, and optional metadata. The custom depth map can then be attached to an image by creating an AVDepthData object from the dictionary and using the Image IO Framework to add this auxiliary data to the image. This allows for custom depth data generation and integration, enabling unique depth-related effects.

Each of the above described articles is incorporated by reference herein in their entirety.

As shown in FIG. 26, in accordance with aspects of the present technology, the strike zone 162 may be displayed on the display screen of the capture device as an augmented reality object floating in space above home plate 102. The augmented reality strike zone 162 may be properly sized and oriented as described above, and may be displayed with a degree of transparency, as shown in FIG. 26. As explained in greater detail below, a visual indication of the augmented reality strike zone 162 may be provided on a display of the image capture device 160 and/or a variety of other display devices having a network connection with the device 160, including for example a field score board display.

Coaches, scouts and others often need to know how fast pitchers are throwing a ball, and there are several expensive devices aimed at satisfying this need. As described above, the BLU application may use various hardware features, machine vision algorithms, monocular depth sensing MLMs and/or heuristic techniques to examine successive image frames to determine the velocity and any positive or negative acceleration of a ball 154 in flight toward home plate. Using the known distance between the pitcher's mound and home plate, and various other features such as a change in position of the ball in each successive frame, the known frame rate, the known overall time it took for the ball to travel to home plate, and any detected positive or negative acceleration, the BLU application may determine and display on GUI 165 a velocity of the ball at a time when the ball leaves a pitcher's hand. When making this determination, the distance between the pitcher's mound and home plate may be adjusted (shortened), by e.g. 3-5 feet, in that the pitcher is in front of the pitcher's mound when the ball leaves his or her hand.

In embodiments described above, it is an object of the BLU application to determine whether a ball is inside or outside of a strike zone 162 at a time when the ball 154 reaches or passes through a vertical plane including the strike zone 162. In further embodiments, the BLU application may be used to determine whether the ball 154 passes through some predefined horizontal plane. For example, often in slow-pitch softball, there is a maximum height limit to a pitch, such as 12 or 15 feet. There is also a minimum height limit, such as 6 feet. The present technology may be used to determine whether a ball exceeds these maximum and/or minimum height limits.

As described above, the BLU application is able to determine parameters of a pitched ball 154, such as velocity and trajectory, by analyzing successive image frame of data captured by capture device 160. Using these parameters, the BLU application is able to determine the apex of a pitch ball. Using the apex information, and stored information regarding the maximum and minimum height limits, the BLU application is able to determine whether the apex is both above the minimum height limit and below the maximum height limit, and by how much. Where a pitch is illegal for having failed either the maximum or minimum height limits, the BLU application can provide some audible and/or visible indicator to this effect. This audible and/or visible indicator may be provided at the time a pitch reaches its apex, or after it crosses home plate.

In embodiments described above, the BLU application captures images of a live event (baseball or softball game) to determine 3D positions and depth along the z-axis of captured objects. Observation of the live event provides useful information used by the hardware features, machine vision algorithms, monocular depth sensing MLMs and/or heuristic techniques to make 3D determinations. However, in further embodiments of the present technology, the BLU application may be used to determine the relative positions of reference and moving objects (such as a ball crossing inside or outside of a strike zone) when capturing images of an event on a television or other screen. In such embodiments, much of the information from the actual 3D event is lost when displayed on a purely 2D screen. However, using at least some of the above-described hardware features, machine vision algorithms, monocular depth sensing MLMs and/or heuristic techniques, the BLU application is still able to make the needed depth and 3D determinations from video display of the event on the screen to detect the relative positions of the reference and moving objects (such as a ball crossing inside or outside of a strike zone). Thus, users may for example watch a baseball or softball game on TV, and user smartphone or other image capture device implementing the BLU application to obtain an independent verification of called balls and strikes.

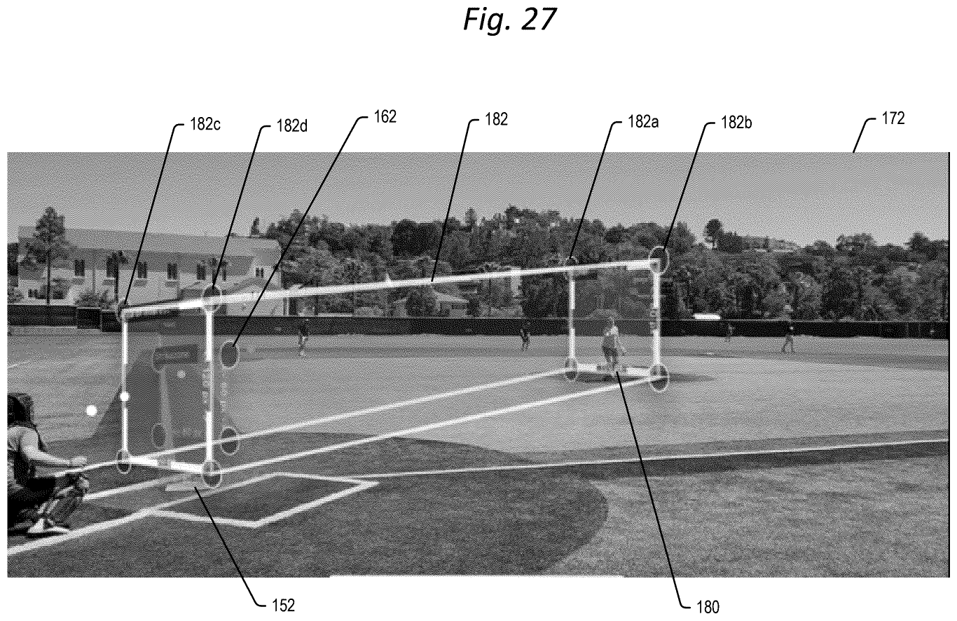

The BLU application may further include additional features which improve its ability to call balls and strikes in a baseball or softball game. Even with the training of BLU, it may happen that BLU identifies objects in an image frame that it believes is the ball 154 in flight, but in fact is not. The present technology may therefore employ techniques for limiting the field of view which may possibly contain a pitched ball 154. Referring now to FIG. 27, there is shown an image 172 captured by device 160 and further including a pitch tunnel 182. The BLU application may be programmed to only track objects within the pitch tunnel 182, therefore reducing the possibility that extraneous objects in the field of view of capture device 160 will be mistakenly identified as ball 154. The pitch tunnel 182 is designed to start at the pitcher's mound 180 and end at home plate 152 (coplanar with or near the strike zone 162). As discussed, detection of these positions may be done by BLU, or they may be designated during the calibration step 251. Alternatively, the end points 182a, 182b, 182c, 182d, etc., of the pitch tunnel 182 may be manually set by clicking and dragging the end points on the display of capture device 160.

The pitch tunnel 182 may be defined to have a cross-sectional area in a vertical plane large enough to capture all or most pitches. It can be customized in further embodiments, for example by dragging and repositioning the corners 182a, 182b, 182c, 182d, etc., on the display of capture device 160. As an example, younger kids may pitch with more of an arc, and the pitch tunnel 182 may be set by the user to have a larger cross-section for such uses. For older kids and adults that throw harder, it can be set to have a smaller cross-section. The larger it is, the more likely it is to capture extraneous objects that might be mistaken for a ball 154. On the other hand, if the cross-section is made too small, a pitched ball may travel outside of the pitch tunnel and not be tracked. However, the likelihood in such cases is that the ball will at some point during its flight reenter the tunnel 182 and be tracked.

The pitch tunnel 182 is useful in improving the accuracy of BLU to detect a pitched ball in flight. However, the pitch tunnel 182 may be omitted in further embodiments. When present, the pitch tunnel may be invisible to the user, or the pitch tunnel may be displayed as a 3D, semi-transparent augmented reality object on the display of capture device 160. The pitch tunnel 182 is shown with a rectangular cross-section, but it may have other shaped cross-sections in further embodiments.

The pitch tunnel 182 is useful in removing objects from consideration that might otherwise be considered a ball 154. However, in further embodiments, instead of using a 3D pitch tunnel, the area encompassed by the tunnel (i.e., the area of interest where a ball travels from the pitcher to the catcher) may instead be cropped from images captured by the image capture device 160. In this embodiment, the 2D cropped images may be examined for a ball 154 and objects outside of the cropped image are removed from consideration as they do not appear in the cropped image. Translation equations and/or matrices may be used to switch the frame of reference from the entire image to the cropped image, and then back again to the entire image after analysis on the cropped image has been completed.

In addition to improving the accuracy of BLU by placing spatial limitations on where to look for a ball 154 in image frames, the present technology may improve BLU's accuracy by also or alternatively placing temporal limitations on when to look for a ball 154 in image frames. In one example, the BLU application may identify when a pitcher has released a ball 154 toward home plate 152. It may at that point begin to detect a ball 154 in flight in the image frames of capture device 160. All pitches, even slow pitches, will reach home plate some predefined time period later. This predefined time period may vary, and may be user defined depending on the level of play and average speed of the pitchers. The BLU application may stop looking for a ball 154 in flight after expiration of the predefined period of time. By limiting the time periods in which the BLU application track objects which may be identified as a ball 154, the present technology reduces the possibility that extraneous objects in the field of view of capture device 160 will be mistakenly identified as ball 154.

In order to use temporal segmentation to limit when BLU looks for a ball, BLU needs to recognize a pitched baseball. BLU may be trained to recognize a pitch toward home plate during the training phase. Pose detection algorithms are known which are capable of detecting movement of a pitcher's joints, or otherwise identifying pitcher movements to identify a pitcher throwing a pitch. BLU may be trained on a large dataset to detect such movement, and, when conforming to a pitch motion, identify that a pitch has been thrown. While there are a wide variety of pitching motions, there are some features common to all, such as the raising of the front leg off the ground and stepping toward home plate, and an arm motion (overhand, underhand, sidearm, etc.) that also moves toward home plate. It is also possible that a pitcher throws to a base (such as first base) in an attempt to pick off a base runner. BLU may also be trained to recognize when a pitched ball is heading toward home plate, as opposed to a base.

In the inference phase, the BLU application may use pose detection algorithms and/or the trained model, together with the 3D map of objects, to identify when a pitch is thrown toward home plate. It may then examine frames from image capture device 160 for a ball 154, until expiration of the predefined period of time. The BLU application may also display on the GUI some indicator representing start of a pitch, such as for example, “The pitch is on the way.”

In embodiments described above, the home plate 152, ball 154, strike zone 162 and the determination of whether a pitched ball 154 is a strike or ball are all determined using a single image capture device 160. In further embodiments, one or more of the home plate 152, ball 154, strike zone 162 and the determination of whether a pitched ball 154 is a strike or ball may be performed by two or more image capture devices 160 set up at different positions to capture field 150. In such embodiments, the multiple capture devices 160 may be used serially. That is, for example, a first capture device 160 may be used when a second capture device 160 does not have a view of home plate 152, and the second capture device 160 may be used when the first capture device 160 does not have a view of home plate 152.

A further embodiment using multiple capture devices 160 may use the capture devices in parallel. That is, for example, the multiple capture devices 160 may each capture images of a pitch. The images from the respective image capture devices may be time synchronized to each other, and pairs of images taken at the same time from the respective capture devices 160 may be used together to identify one or more of the home plate 152, ball 154, strike zone 162 and the determination of whether a pitched ball 154 is a strike or ball.

In still further embodiments, the BLU application may be implemented by multiple devices networked together. In this example, the image capturing features of the BLU application may be performed by a device with a powerful camera, such as for example a GoPro camera, and the processing and computational features of the BLU application may be performed by a device with one or more powerful processors such as for example a smartphone, tablet, laptop or desktop computer.

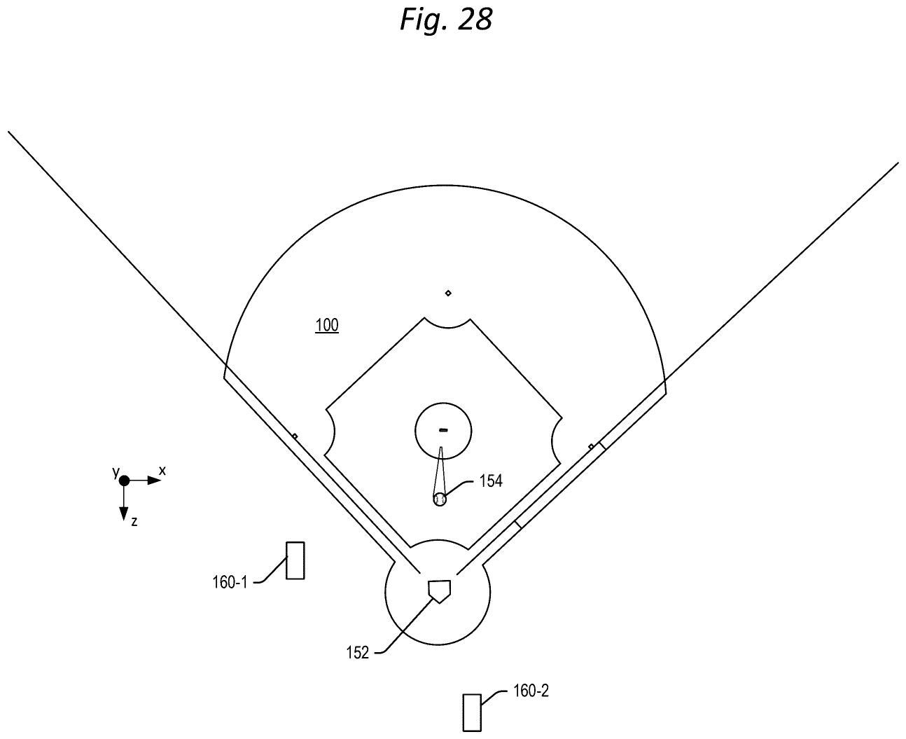

In embodiments described above, the BLU application is implemented on a single image capture device such as a single iPhone or other smart phone. In further embodiments, the present technology may be implemented using two (or more) iPhones or other smart phones. Such an embodiment is described with respect to FIG. 28. FIG. 28 shows a pitched baseball 154 heading toward home plate 152. In this example, a Cartesian coordinate system is used including a z-axis between the pitcher's mound and home plate, an x-axis perpendicular to the z-axis and indicating horizontal position, and a y-axis (into and out of the page) perpendicular to the x and z axes and indicating vertical position.

In an example of this embodiment, the BLU application is implemented on a pair of image capture devices 160-1 and 160-2 which are iPhones or other smart phones. Executing the BLU application, the two image capture devices 160-1, 160-2 together determine the 3D position (x, y, z coordinates) of a pitched ball 154 as it travels toward home plate 152. When the ball arrives at home plate (the z-direction), the BLU application determines the x and y coordinates of the ball 154 to determine whether the ball is inside or outside of the defined strike zone over home plate.

The two smart phones 160-1, 160-2 may work together in a variety of ways to determine the 3D position of the baseball. The phones may be time synchronized to each other using a network connection such as Bluetooth or local area network. As the baseball travels from the pitcher toward home plate, both smartphone cameras record the ball's motion at one of various frame rates (e.g., 60 to 240 fps). Using the training of the BLU machine learning model, the BLU application identifies the baseball in each video frame on each smart phone. Apple's ARKit and LiDAR can further refine depth perception by measuring distance in real time.

In this example, the distance between the two smart phones 160-1 and 160-2 may be known. If not, an initial calibration may be performed to orient both smart phones to the shared (common) x, y, z Cartesian reference frame between the smart phones. This may be done by detecting fixed reference points that both cameras can see, such as the home plate corners, the pitcher's mound rubber, any marked points on the field (e.g., bases, foul lines), etc. Using computer vision techniques like homography, perspective transformation, or ARKit-based world tracking, the software aligns both cameras to a common Cartesian reference frame.

Both smart phones 160-1, 160-2 may capture video frames at the same time. Given the different positions of the smart phones, each camera has a different viewpoint, the same baseball appears at different positions in each frame. Once the relative camera positions are estimated, the system proceeds to track the baseball. Each smart phone 160-1, 160-2 individually detects the ball 154 and tracks its motion over time. The system may use motion prediction models to improve tracking accuracy.

Since the ball 154 appears at different positions in the two camera views, the BLU application measures parallax, i.e., the disparity or positional difference between the smart phones to calculate the ball's depth (z-coordinate). The system may then extrapolate and/or determine the trajectory of the ball using motion modeling and physics-based calculations to determine the x, y coordinates at the instant it crosses the z=0 plane (home plate). If the x,y coordinates lie inside the defined strike zone (explained above), the pitch is called a strike. If the x,y coordinates lie outside the defined strike zone, the pitch is called a ball.

While FIG. 28 shows two exemplary positions of smart phones 160-1 and 160-2, it is understood that this embodiment may work with the smart phones 160-1 and 160-2 positioned in any of a wide variety of positions, with the caveat that the positions of the two smart phones should not be the same in this embodiment. There may be more than two smart phones 160 in this embodiment as well.

### Bullpen Use

As noted above, the BLU application may be used to track balls and strikes during a game on a field 150. However, a further use of the BLU application is to track balls and strikes during a bullpen session. The BLU application is well-suited to such a use as bullpen sessions do not have umpires, and all that is needed is a ball/strike determination (as opposed to other in-game umpire calls). The BLU application can identify home plate and mound in such bullpen sessions according to any of the above-described embodiments. At that point, the BLU application can operate as described above to determine whether each pitch in the session is a ball or strike. As noted above, the BLU application can further determine the velocity of each pitch.

The BLU application can further store this information in a database and to organize this information for display, such as for example to display of a scatter chart showing all of the pitches from a bullpen session of a pitcher, and which were balls vs. strikes. A velocity report may also be easily generated. This information may be stored and accessed for each pitcher, providing an easy summary of the pitcher's abilities.

### Other Sports and Activities

In embodiments described above, the BLU application is used to determine in a 3D reference frame when a pitched ball crosses through a plane including a strike zone and home plate to make a ball or strike determination. This is one of many examples where the present technology is able to determine in a 3D reference frame the relative positions of one or more moving objects relative to one or more reference objects. Within baseball and softball, there are additional examples. The BLU application may be used to determine when a runner's foot (moving object) contacts a base (reference object) and compare that with the time that a ball (moving object) reaches the base (reference object). In this way, the BLU application may be used to make safe/out calls of runners on bases. The BLU application may further be used to determine whether a fielder (moving object) contacts a base runner (moving object) before the base runner contacts a base (reference object) to make safe/out calls where there is no force play. The BLU application may be used to determine where a ball (moving object) lands relative to a foul line (reference object) when the ball lands in a horizontal plane of the foul line. It is understood that one or more additional capture devices 160 may be provided, at multiple locations on or around the field 150, in addition to the above-described image capture device 160, to aid in making these safe/out and fair/file determinations.

As is also noted above, the present technology may be used to determine the relative positions of reference and moving objects in sports other than baseball/softball. For example, in the game of cricket, it is often necessary to determine relative positions of a moving and reference object, such as for example whether a bowled ball hits or misses the stumps, or whether a batsman reaches the crease of the opposing wicket before the opposing team reaches the wicket with a struck ball. The machine learning model of the present technology may be trained to recognize the ball and wickets as described above. The inference of such an MLM may be used during cricket games to make these determinations.

In a further example, the present technology may be used in any of a wide variety of racket and ball sports. For example, in tennis, a machine learning model may be trained to recognize a tennis ball (moving object) in flight as well as the positions of the base line, sidelines and service lines (reference objects). This machine learning model may then be used during a tennis match to determine whether a tennis ball lands inside or outside of the various boundary lines. The above-described U.S. Pat. No. 11,893,808, to Sahai et al, entitled “Learning-Based 3D Property Extraction,” discloses a similar system. However, one key distinction between the '808 Patent and the present technology is that the present technology is trained using only a single capture device, and is trained using only 2D images from the single capture device.

In the same way, the present technology may be used in a wide variety of other sports to detect the relative positions of a ball (moving object) and a boundary or goal line (reference object) when the ball is in the horizontal and/or vertical plane of the boundary or goal line. These other sports include for example volleyball, football, basketball and soccer. In the same way, the present technology may be used to determine the relative positions of a hockey puck (moving object) relative to the center lines, blue lines and goal lines when the hockey puck is in the horizontal or vertical planes of the center lines, blue lines and goal lines.

### Slow Motion Mode

As noted above, depending on the speed of the pitch and the image frame rate, it may happen in the inference of BLU that an image frame is examined but no ball is found. In accordance with further aspects of the present technology, the BLU application may initiate a slow motion mode during a pitch to speed up the frame rate to ensure that the ball 154 appears in each frame. In such embodiments, the BLU application may detect when the ball 154 leaves the hand of a pitcher. Upon such detection, the BLU application may communicate with a frame rate controller of the image capture device 160 to change the video capture from normal speed to slow-motion speed. Upon completion of a pitch, the BLU application may again communicate with the frame rate controller to change the video capture back to normal. Completion of a pitch may be detected in a variety of ways, including detection of the ball 154 passing through or beyond the plane of the strike zone 162, or a discontinuous motion of the ball 154. Using this mode, it ensures or makes more likely that a fast moving ball 154 will appear in each frame of video from capture device 160. In addition to implementation of this mode within the inference phase of BLU, this slow motion mode may also be performed during the training phase to improve the quality of data used to train BLU.

### Batting Cages

In a further embodiment, the BLU application may be implemented in batting cages to call balls and strikes. As pitches come in, the batter may be informed as to whether a pitch was a ball or strike, further enhancing the process.

Verbal Interaction with the BLU Application

In further embodiments of the present technology, the BLU application may also be configured as a smart digital assistant, able to answer questions and engage in verbal interactions. This aspect of the BLU application may be triggered by a wakeword, such as for example, “HEY BLU.” The smart digital assistant may be configured to answer any of a wide variety of queries related to a baseball or softball game, but some examples include:
“HEY BLU, what's the count?”
“HEY BLU, how many outs are there?”
“HEY BLU, what's the score?”
“HEY BLU, where did that pitch miss?”
“HEY BLU, was that a foul tip?”
“HEY BLU, you missed that call. We want to challenge.”

The BLU application may also store the current state of a game (score, batter count, inning, etc.) as well as all rules pertaining to baseball and/or softball games. Thus, the smart digital assistant may be configured to answer any of a wide variety of questions or clarifications relating to the game or the rules of baseball or softball. The smart digital assistant of the BLU application may be configured to answer a wide variety of other questions as well. For this embodiment, a large language model (LLM) may be trained specifically on baseball and/or softball related topics. Alternatively, the BLU application may have access to existing LLMs, such as for example chat GPT. Such LLMs are particularly adept at handling questions such as those above independent of the form of the question.

### Visual Indications of Balls/Strikes

In embodiments of the present technology, for example those intended to assist an umpire, the BLU application may give a simple audible sound to an earpiece worn by the umpire indicating whether pitch was a ball or strike. However, as indicated, the BLU application may also be configured to provide a visual indication of whether pitch was a ball or strike. Such visual indications may be displayed in real time on a display of device 160, and/or used for example when a ball/strike call is challenged. At that point, the BLU application may provide a visual indication of the strike zone 162 (for example as shown in FIG. 26), and where the pitched ball 154 was relative to the strike zone 162. This visual indication may be provided on the image capture device 160 and/or a variety of other display devices having a network connection with the device 160. Such other display devices may include for example an LCD display scoreboard visible to the players, coaches and fans watching a game. In a further embodiment, the BLU application may be monitored by someone wearing a virtual or augmented reality headset. In such embodiments, the field graphic (for virtual reality), the pitch location, strike zone, home plate, ball/strike indication and a variety of other information may be projected onto the virtual or augmented reality headset.

Additionally, graphics may be provided to enhance the visual indication of the ball or strike. For example, the strike zone may be displayed on the capture device 160 and/or other associated display devices as a pane of glass which shatters if a pitched ball was a strike. Other graphical enhancements may include displaying the pitched ball as a missile, and the display showing the zone blowing up for pitched ball was a strike. A variety of other graphical enhancements are contemplated.

Adjust Confidence Threshold for Identifying a Pitched Ball and/or Home Plate

For each video frame analyzed, BLU may have a predetermined confidence threshold with which a pitched ball and/or home plate are identified within that video frame. Where the confidence threshold is low, BLU is more likely to identify a pitched ball and/or home plate within a video frame, but the chances are greater that BLU will make a mistake in identifying a pitched ball and/or home plate. Alternatively, where the confidence threshold is high, BLU is less likely to identify a pitched ball and/or home plate within a video frame, but the chances are less that BLU will make a mistake in identifying a pitched ball and/or home plate. End users may be given the option to adjust the confidence threshold as desired. In further aspects of the present technology, the BLU application may also return a confidence level with which a pitched ball and/or home plate are identified within a given video frame. Such a confidence level may be displayed for example as a percentage on the image capture device 160.

### Non-Real Time Analysis of Baseball/Softball Pitches

In embodiments, the BLU application is configured to make ball/strike calls at a field 150 in real time, i.e., as a pitch happens. However, in further embodiments described above, an image capture device 160 may be set up to view video of a game, for example displayed on a TV remote from the field. In such embodiments, the BLU application may operate as described above to detect home plate and a pitched ball from the video of the video, and determine whether the pitched ball from the video is a ball or strike. Using the BLU application in this way allows users to review video of pitches after a game or otherwise after they occur to determine whether they were correctly called as a ball or strike. Using the BLU application this way also allows users to independently call balls and strikes as they are watching a video broadcast of pitches during a game or otherwise.

### Calibration of BLU at a Field

As described above, the training phase uses a large number of video images to teach BLU to identify a ball and home plate under a wide variety of conditions. As described above, the BLU application may perform a calibration step 251 where a 3D map of the field may be formed. Additionally, in a further aspect of the present technology described above, upon arriving at a field, video of the field, warm up pitches, player uniforms, etc. may be captured and uploaded to the model responsible for training BLU. These uploaded images may be used to further train BLU, in real time, and to hone BLU's ability to identify a ball and home plate at the actual field on which the BLU application is to be used. Once further trained on the specific field, the updated version of BLU may be accessed from the server and, possibly, downloaded to the image capture device 160 for use during the game at that field.

### Pitch Counts

Many leagues have pitch count limits. For example, in most little leagues, if a pitcher pitches a first number of pitches, the pitcher cannot pitch for a first number of days, if the pitcher pitches a second greater number of pitches, the pitcher cannot pitch for a second greater number of days, etc. In a further embodiment, the BLU application can identify a pitcher (or at least distinguish a first pitcher from a second pitcher from a third pitcher, etc.), and can keep track of the number of pitches that each pitcher has thrown. This information may be made available to coaches and/or league officials. The BLU application can also be trained with the specific pitch limits for specific leagues, and can prompt a coach which a pitcher is approaching his or her pitch limit for that league.

### The BLU Application Can Work With or Without an Umpire

In embodiments, the BLU application can be used to assist and umpire, verifying calls made by the umpire. In such embodiments, the ball/strike result determined by the BLU application can result for example in an audible sound on either a pitched ball or pitched strike, played into an earpiece worn by the umpire (or a first tone for a ball and a second different tone for a strike). In such embodiments, the BLU application works in the background, and the umpire makes all ball/strike calls. BLU is referred to as an assistant in this embodiment.

In a further embodiment, BLU may be trained to operate without an umpire. BLU is referred to as an umpire in this embodiment. The BLU umpire embodiments require additional training than for the umpire assistant embodiment. As one example, if a pitch is a ball, but the batter swings, the BLU application would indicate a ball, but in fact under the rules of baseball, that would be a strike. Thus, in BLU umpire embodiment, additional training is necessary. For example, in addition to learning to identify a pitched ball and home plate, BLU in this embodiment may also learn to identify a bat in the hands of a batter, and whether or not the bat is swung on a given pitch. BLU may also be trained to detect contact with a baseball, and whether the baseball travels into fair or foul territory. BLU may also be trained, given enough video data, to detect other calls made by an umpire, such as for example:
a check swing,
a dropped third strike in a scenario where a runner can run to first base (no one on first base or there are two outs),
a foul ball classified as a strike (less than 2 strikes) or simply dead ball (at 2 strikes),
whether a pitch hits the ground before it is caught,
catcher interference.

Each of these abilities (and others) may be learned by BLU to effectively make these calls in the inference phase given sufficient video training data showing each of these features.

The BLU application may further be equipped with algorithms for keeping track of a baseball game. As noted above, the BLU application calls and stores balls and strikes for each batter. The BLU application may further keep track of the inning (including top or bottom), score, outs in an inning, what bases are occupied and the identity of the batter(s) on base. In embodiments, this information may be displayed on device 160 and/or other display(s).

The BLU application can further be used to automatically (without user assistance) identify hits, and what type of hits they are (single, double, triple or homerun), where in the field those hits are, as well as distinguish between hits vs. errors. In embodiments, the type of hit and location of the hit automatically detected may be displayed on device 160 and/or other display(s). For example, a pop out may be displayed as a graphical ball displayed with a contrail flying in an arc and being caught when it comes down. Line drives may be shown as a graphical ball displayed with a contrail flying in a straight-line above ground and being caught or not caught. A bouncing hit may be displayed as a graphical ball displayed with a contrail bouncing along the ground and being caught or not caught. A ground ball may be displayed as a graphical ball displayed with a contrail rolling along the ground and being caught or not caught.

Identifying hits, the type of hits and distinguishing between a hit vs. an error may be accomplished in the training phase of BLU. Given sufficient training data, BLU will be able to identify hits, what type of hit is (in conjunction with image data showing the location of the batter at the conclusion of the play), and whether a particular hit ball is a hit or an error. Using this information in the inference phase, the BLU application can effectively track all aspects of a baseball or softball game, in effect keeping a virtual scorebook of the game. In embodiments, this virtual scorebook may graphically rendered on device 160 and/or other display as an image of a traditional scorebook page, with players names filled in, and their plate appearance results by inning. This information may be determined by BLU and/or the BLU application and, possibly, edited by a user reviewing BLU's determinations.

Additionally, the BLU application may update a database (either locally on device 160 or remote from 160) keeping all player stats, as determined by the BLU application during a game and, possibly, as edited by a user reviewing BLU's determinations.

In addition to or instead of being trained as part of BLU, at least some of these features may be performed algorithmically in the BLU application. For example, once trained to identify a bat in video frames, the BLU application may detect when the bat and ball meet each other (occupy the same space in a given frame of video), and also identify and track a discontinuous path of the ball. The discontinuous path is shown by the ball heading along a first trajectory toward home plate, and then its trajectory changes discontinuously.

The present technology provides significant advantages over prior automated umpiring systems. Unlike conventional systems, the present technology may be used to call balls and strikes as well as other umpire duties using a single, off-the-shelf mobile device such as an iPhone implementing a trained machine learning model. Moreover, unlike conventional systems, the present technology does not require adherence to strict set up or implementation procedures. The mobile device used to call balls and strikes may be positioned in any of a wide variety of convenient, user-selected locations behind home plate. Further still, the BLU application may be fully downloaded onto and implemented from the capture device 160. As such, in embodiments, no network or Internet connection is needed. Thus, the BLU application can be used on fields in remote areas and other areas without connectivity to the Internet.

As noted in the Background section, there is a national shortage of umpires for all levels of amateur baseball and softball. The present technology solves this shortage, providing easily accessible and inexpensive umpiring services to all levels of baseball and softball, including for example youth, club, junior high, high school and adult league and tournament play.

As described above, embodiments of the present technology may be simply implemented using a single image capture device such as a mobile phone during both the training phase and inference phase. In further embodiments of the present technology, two or more image capture devices, such as two or more mobile phones, may be used simultaneously to capture training images and/or used in the inference phase to calls balls and strikes. In such embodiments, the two or more image capture devices may be time synched to each other to correlate image video frames with each other. In such embodiments, each such image capture device may operate as a pier, or one such image capture device may be designated as the master and the other devices slaves to that master.

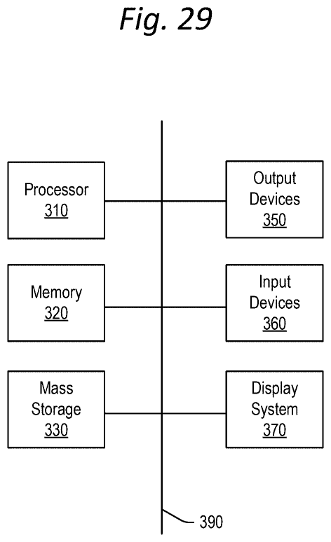

FIG. 29 illustrates an exemplary computing system 300 that may be any of the mobile phones or capture devices 110, 160 used to train and implement embodiments of the present technology. The computing system 300 of FIG. 29 includes one or more processors 310 and main memory 320. Main memory 320 stores, in part, instructions and data for execution by processor unit 310. Main memory 320 can store the executable code when the computing system 300 is in operation. The computing system 300 of FIG. 29 may further include a mass storage device 330, portable storage medium drive(s) 340, output devices 350, user input devices 360, a display system 370, and other peripheral devices 380.

The components shown in FIG. 29 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive, an optical disk drive or a solid state drive, is a non-volatile storage device for storing data and instructions for use by processor unit 310. Mass storage device 330 can store BLU and other algorithms for implementing embodiments of the present technology and for loading that software into main memory 320.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 29 includes output devices 350. Suitable output devices include speakers, network interfaces, and a display.

Display system 370 may include a liquid crystal display (LCD) or other suitable display device. Display system 370 receives textual and graphical information, and processes the information for output to the display device.

The components contained in the computing system 300 of FIG. 29 are those typically found in computing systems that may be suitable for use with embodiments of the present invention and are intended to represent a broad category of such computer components that are well known in the art. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a USB drive, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

We claim:

1. A system for determining a position of a moving object relative to a reference object in a sporting event from image frames of the sporting event captured by an image capture device, comprising:
one or more processors configured to implement a machine learning model trained to identify the moving object and the reference object in one or more of the image frames;
wherein the machine learning model is trained using a single image capture device.

2. The system of claim 1, wherein the single image capture device is an off-the-shelf smartphone.

3. The system of claim 1, wherein the single image capture device is one of an iPhone, an Android phone, a Google phone, and a GoPro camera.

4. The system of claim 1, wherein the moving object is one of a baseball and a softball and the reference object is a home plate.

5. The system of claim 4, wherein the one or more processors are further configured to construct a strike zone over the home plate, and wherein the processor is further configured to size, position and orient the strike zone over home plate.

6. The system of claim 5, wherein the one or more processors are further configured to identify a pitcher's mound, and the one or more processors are configured to orient the strike zone over home plate by directing the strike zone to face the pitcher's mound.

7. The system of claim 5, wherein the one or more processors are further configured to determine an image frame where the baseball or softball reaches a plane in which the strike zone is positioned, and to determine whether the baseball or softball passes through the strike zone at the image frame to constitute a strike, or whether the baseball or softball misses the strike zone at the image frame to constitute a ball.

8. A system for determining a position of a moving object relative to a reference object in a sporting event from image frames of the sporting event captured by an image capture device, comprising:
one or more processors configured to implement a machine learning model trained to identify the moving object and the reference object in one or more of the image frames;
wherein the machine learning model is trained using only two-dimensional data.

9. The system of claim 8, wherein the machine learning model is trained using ground truth data in which positions of at least one of the moving and reference objects are manually labeled.

10. The system of claim 8, wherein the machine learning model is trained using ground truth data in which positions of at least one of the moving and reference objects are automatically labeled.

11. The system of claim 10, wherein the sporting event is a baseball or softball game, the moving object is one of a baseball or softball and the reference object is a home plate, and wherein the ground truth data for identifying home plate is automatically labeled using known positions of one or more features of a baseball field relative to the home plate, the one or more features comprising one or more of first base, second base, third base, a pitcher's mound and foul lines.

12. The system of claim 10, wherein the sporting event is a baseball or softball game, the moving object is one of a baseball or softball and the reference object is a home plate, and wherein the ground truth data for identifying the baseball or softball is examining successive image frames of the image frames to automatically identify an object in the successive image frames following a path of a thrown baseball or softball.

13. The system of claim 8, wherein the moving object is one of a baseball and a softball and the reference object is a home plate.

14. The system of claim 13, wherein the one or more processors are further configured to construct a strike zone over the home plate, and wherein the processor is further configured to size, position and orient the strike zone over home plate.

15. The system of claim 14, wherein the one or more processors are further configured to identify a pitcher's mound, and the one or more processors are configured to orient the strike zone over home plate by directing the strike zone to face the pitcher's mound.

16. The system of claim 14, wherein the one or more processors are further configured to determine an image frame where the baseball or softball reaches a plane in which the strike zone is positioned, and to determine whether the baseball or softball passes through the strike zone at the image frame to constitute a strike, or whether the baseball or softball misses the strike zone at the image frame to constitute a ball.

17. A system for determining a position of one of a baseball and softball relative to a home plate in a baseball or softball game from image frames of the baseball or softball game captured by an image capture device, comprising:
one or more processors configured to:
implement a machine learning model trained to identify the home plate and the baseball or softball in one or more of the image frames,
construct a strike zone over the home plate,
size, position and orient the strike zone over home plate,
determine an image frame where the baseball or softball reaches a plane in which the strike zone is positioned, and
determine whether the baseball or softball passes through the strike zone at the image frame to constitute a strike, or whether the baseball or softball misses the strike zone at the image frame to constitute a ball.

18. The system of claim 17, wherein the one or more processors determine the image frame where the baseball or softball reaches the plane in which the strike zone is positioned by measuring an increase in the number of pixels comprising the ball or softball in the image frames.

19. The system of claim 17, wherein the machine learning model is trained using a single image capture device.

20. The system of claim 17, wherein the machine learning model is trained using only two-dimensional data.

21. The system of claim 17, wherein the machine learning model is trained on a single image capture device using only two-dimensional data.
